(19) United States
(12) Patent Application Publication
(10) Pub. No.: US 2008/0288275 A1
(43) Pub. Date: Nov. 20, 2008

(54) TRIP REPORT MANAGEMENT SYSTEM FOR CLINICAL MONITORING

(75) Inventors: John W. Houriet, JR., Yardley, PA (US); Jianbo Peng, Drexel Hill, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: NUMODA TECHNOLOGIES, INC., Philadelphia, PA (US)

(21) Appl. No.: 12/119,846

(22) Filed: May 13, 2008

Related U.S. Application Data
(60) Provisional application No. 60/917,819, filed on May 14, 2007.

(51) Int. Cl. G06Q 99/00

(52) U.S. Cl. 705/1

(57) ABSTRACT

A computer-implemented method is provided for managing trip reports related to clinical monitoring, wherein each trip report includes a trip status. An administration computer maintains a plurality of trip reports associated with a clinical study. Trip reports are entered into the administration computer. A user interface allows authorized users to view the trip reports and change the status of the trip reports in the administration computer. The administration computer produces a summary report showing at least the status of selected trip reports.

### CROSS-REFERENCE TO RELATED APPLICATIONS

This application claims the benefit of U.S. Provisional Application No. 60/917,819 filed May 14, 2007.

### BACKGROUND OF THE INVENTION

Pharmaceutical, Biotechnology, Bio-Pharmaceutical or Medical Device companies and academic researchers conduct clinical studies to evaluate the safety and efficacy of their products to help determine suitability for the market. These groups or companies are known as clinical trial Sponsors. Part of the clinical study is to collect a variety of clinical data on patients to test the product in a controlled setting. These data are typically presented by the Sponsor in a variety of formats, including various statistical analyses and presented to appropriate regulatory agencies, such as the Food and Drug Administration for review and approval.

Clinical study teams can be comprised of many individuals from many organizations from many countries. In addition to the Sponsor, there is usually a group or groups tasked with conducting the study on behalf of the sponsor. These companies are known as Clinical Research Organizations (CROs). In addition to the Sponsor and CROs, the study employs Clinical Sites (Site) managed by a physician known as the Principal Investigator. (PI) Sites are typically a doctor's office, hospital or clinic depending upon the therapeutic area of the study itself. Each Site will recruit and enroll patients into the study until the number of patients required for the appropriate statistical analyses has been reached. The larger the study, and the more countries involved, the need for staff increases, and oftentimes the number of Sites and CROs required for conducting the study also increases.

The integrity of the data collected in the study is paramount to the success of the study. The Sites' staff, as defined by the Sponsor, must carefully execute the clinical protocol. All data must be properly recorded and compliance with Good Clinical Practice (GCP) and other appropriate regulations for the study conduct, locally and globally must be maintained. In order to ensure data integrity and regulatory compliance, personnel are dispatched to the Sites to review clinical data, protocol compliance and regulatory compliance. These personnel are known as Study Monitors (Monitors) or Clinical Research Associates (CRA) and make several trips to clinical sites to review the status of the study at a given clinical site. Each visit will instantiate a report by the monitor that summarizes the content of the visit. The formats and specific content of each report may vary depending upon the design of the clinical study, the work practices and standard operating procedures for the CRO that provides the Monitors, and the details of the visit itself. It is often valuable to allow the diverse companies that provide the monitoring services to operate within their existing work practices rather than dictate centralized practices that have no material impact on the work itself. This reduces the need for additional training for a work staff that is usually very busy. These Monitors can be contract Monitors or in-house monitoring staff.

Monitors usually make four types of monitoring visits to each site. However, there may be more types if required by the Sponsor or CRO, or if dictated by the clinical protocol. The first type is a Pre-Study (PS) visit. The Monitor will evaluate the Principal Investigator, their staff, experience, facility and related licensure to determine if the site is suitable for conducting the study. The Monitor will create and submit a Pre-Study trip report, in content and format according to the SOPs of the CRO for which they are employed. The second type of visit is known as an Initiation Visit. The Monitor will typically verify the presence of licenses, CVs, financial disclosures, contracts, budget and signatures. In addition, the Monitor will document the review of key clinical study practice information with each staff member who will participate in the management of the study at that Site. Again, the Monitor will file an Initiation Visit Trip Report documenting the content of the visit in the format required by the CRO. The third type of visit is a Routine Monitoring Visit. The Monitor will periodically visit the site during the running of the study itself. In addition to some of the information collected during the previous visits, the Monitors will review the data collected for each patient to ensure it has been properly recorded from source material, such as the patient's medical chart. The Monitor again will submit a Routine Monitoring Visit report once the visit is complete. There may be one or several Routine Monitoring Visits needed during the study depending on the duration of the study or the number of patients at each site. The last type of visit is a Close-Out Monitoring Visit. The Monitor will do a final review of the clinical data, verify regulatory and protocol compliance, and verify that a series of study termination activities have been performed by the site. When completed, the Monitor will submit a final Close-Out Monitoring report.

If a Monitor is part of a CRO staff, each visit performed, and subsequent report by a Monitor will have a significant fee from the CRO to the Sponsor for the work performed. Typically, Sponsors are billed for any and all travel expenses, time on site, and for the time to prepare the report. The typical visit is one to two days depending on the complexity of the visit. A large study with many Sites, multiple CROs and many Monitors will generate a large number of trip reports. Sponsors often receive an invoice from the CRO for each monitoring visit, but the sponsors do not have a way to effectively reconcile the invoices against the actual work performed. Additionally, there is no way to evaluate the qualitative aspects of each report without receiving a copy of the report, creating a significant paperwork challenge for the Sponsor. In other words, if a Sponsor is going to pay for a visit, they would like to know the work done by the Monitor was satisfactory prior to making payment. All of this is especially true with large, complicated clinical studies running in multiple countries with varying trip report practices generating hundreds, or in some cases thousands, of trip reports, as the monitoring portion of a clinical study could account for a large percentage (25%-35%) of the operational budget.

### BRIEF SUMMARY OF THE INVENTION

This system provides a means to collect all the trip reports, regardless of the format templates, and regardless of the mechanism of collection used by each CRO, in a central repository for review, approval, query and accounting accrual by the Sponsor. (A query in clinical terms is a question about clinical or administrative information, as opposed to a computer query into a database.) Each report may then be recorded and viewed in its own format as dictated by the SOPs for each CRO. The Sponsor then has the ability to accept the report as is, or create a query related to that report before it may be marked as accepted. The Monitor or their management may then respond to the query, and/or upload a new or corrected version of the report if required. The Project Manager at the Sponsor then has the ability to easily ensure all trip reports have been reviewed and approved, and of a work quality acceptable for payment to the CRO. This eliminates the need for the Sponsor to manage thousands of pages of documents related to the monitoring process. This process can be used by both in-house and contract Monitors.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a schematic representation of the trip report management system and the relationship of the objects.

FIG. 2 is a flow diagram of the overall process for managing the trip reports.

FIG. 3 is a flow diagram to configure contact information for the clinical sites.

FIG. 4 is a flow diagram showing how to configure users for the trip report management system.

FIG. 5 is a flow diagram showing the process of uploading a trip report to the trip report management system.

FIG. 6 is a flow diagram showing how the trip reports status criteria are selected and how the trip report status is displayed.

FIG. 7 is a flow diagram showing how the trip report summary report is created.

FIG. 8 is a flow diagram showing how a trip report query is created and a response is accepted.

FIG. 9 is a flow diagram showing how a query response is created.

FIG. 10 is a system block diagram with an example of how various users might access the system, and how the data center that might host the trip report management system might be configured.

FIG. 11 is the database structure for the trip report status.

FIG. 12 is the database structure for audit table.

FIG. 13 is the database structure for the query information table.

FIG. 14 is the database structure for the user configuration table.

FIG. 15 is a sample of the login screen for the system.

FIG. 16 is a sample of the main menu to the system.

FIG. 17 is a sample of the selection for the trip report management system from the monitoring menu.

FIG. 18 is a sample of the choice to upload or review reports.

FIG. 19 is a sample of the upload function.

FIG. 20 is a sample of the choosing the region or country to display the trip report status or summary.

FIG. 21 is a sample of selecting the site(s) date range, and report status to display on the trip report summary.

FIGS. 22a and 22b are samples of the trip report summary and trip report status.

FIG. 23 is a sample of report view function.

FIG. 24 is a sample of the query function.

FIGS. 25a and 25b are samples of the query response function.

FIG. 26 is a sample of the administrative menu choices.

FIGS. 27a and 27b are samples of the user configuration list.

FIG. 28 is a sample of editing an existing user configuration.

FIG. 29 is a sample of creating a new user configuration.

FIGS. 30a-30c are an example of a Pre-Study trip report template that may be completed by a monitor and uploaded to the system.

FIGS. 31a-31d are an example of an Initiation trip report template that may be completed by a monitor and uploaded to the system.

FIGS. 32a-32e, are an example of a Routine trip report template that may be completed by a monitor and uploaded to the system.

FIGS. 33a-33f are an example of a Close-Out trip report template that may be completed by a monitor and uploaded to the system.

### DETAILED DESCRIPTION OF THE INVENTION

The present embodiment of the invention uses a computer-based electronic system for collecting, reviewing, querying, and approving clinical monitoring trip reports generated in a variety of formats. In addition, the system displays the management status of each report and summarizes the monitoring visits completed for accounting purposes.

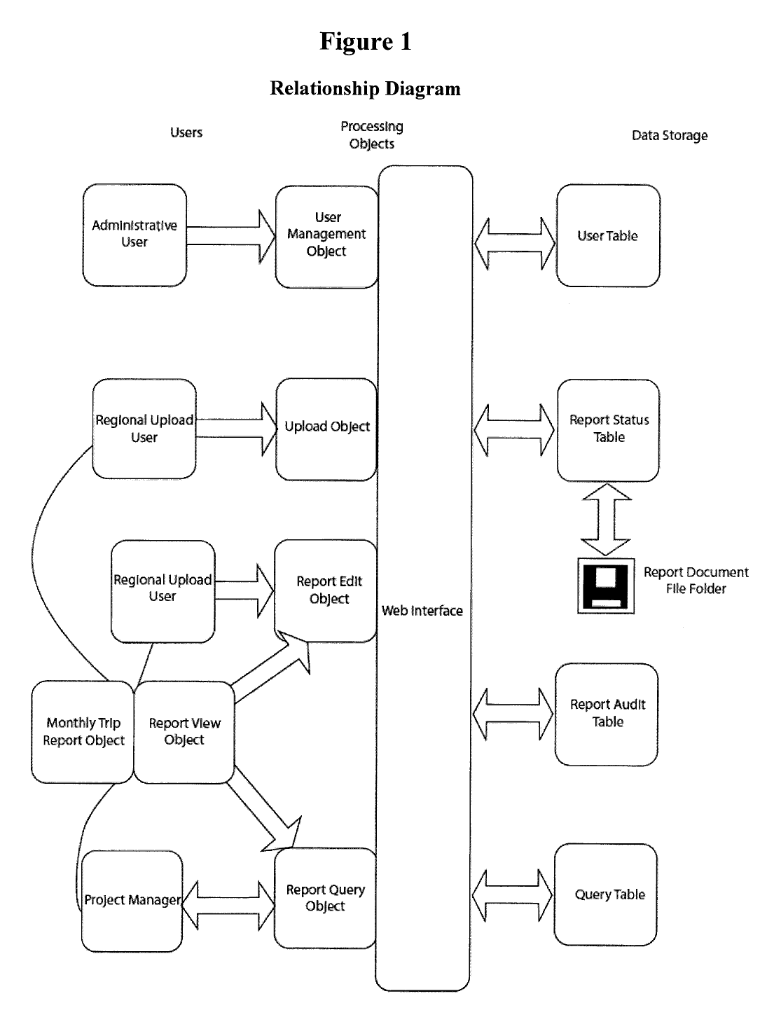

The system uses programming objects to present data entry screens to users via a web browser interface. System users are provided role-based access to enter data and upload monitoring trip reports. The data and reports are stored in a database though a web interface using a series of processing objects (FIG. 1). Additional processing objects could be added to perform additional functions. An administrative user can create the access identity for other system users as follows:

| User Type | Type of Access |
|---|---|
| Sponsor | Views reports and summary data for all regions |
| | Can mark trip reports as accepted |
| | Can generate a query against a trip report |
| Project Manager | Views reports and summary data for all regions |
| | Can upload trip reports |
| | Can respond to queries generated by Sponsor |
| | Can edit reports for all regions |
| | Can generate query against a trip report |
| Region Manager | Views reports and summary data for their specific |
| | region(s) |
| | Can upload trip reports |
| | Can respond to queries generated by Sponsor |
| | Can edit reports for their specific region(s) |
| | Can generate query against a trip report for their |
| | region(s) |
| Region Upload | Can upload monitoring trip reports for their region(s) |
| | Can view summary lists for their regions(s) |
| | Can edit trip reports for their region |
| Administrator | Perform Sponsor tasks |
| | Manage user access |

Other functions and user types could be added, as there is no limit to the interactions except as designated by request. The audit trail log, however, is maintained to all interactions where existing data is changed.

The users in the table above can perform tasks using the following system objects depicted in FIG. 1 and described below.

“User Management Object” uses 3 fields:

| | | |
|---|---|---|
| 1. Login | char | Actual user name |
| 2. Role | char | User type from table above |
| 3. Region | char | County or region as required by the project |

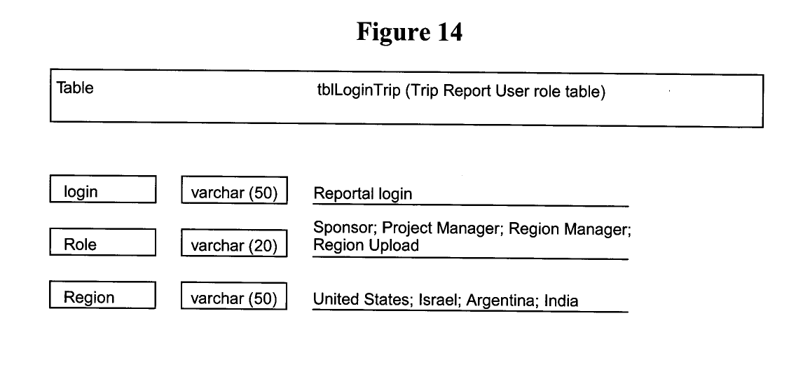

The data collected from this object is stored into User Table (tblLoginTrip) as shown in FIG. 14. “Upload Object” uses 6 fields:

| | | |
|---|---|---|
| 1. File Name | char | Trip report file name |
| 2. Site | integer | Site Number |
| 3. Trip Type | char | Pre-Study, Initial, Routine, Closeout |
| 4. Trip Date | mon dd yyyy | Date of the vist |
| 5. Duration | float | Length of the visit in days |
| 6. UploadPerson | char | Name of person uploading the report |

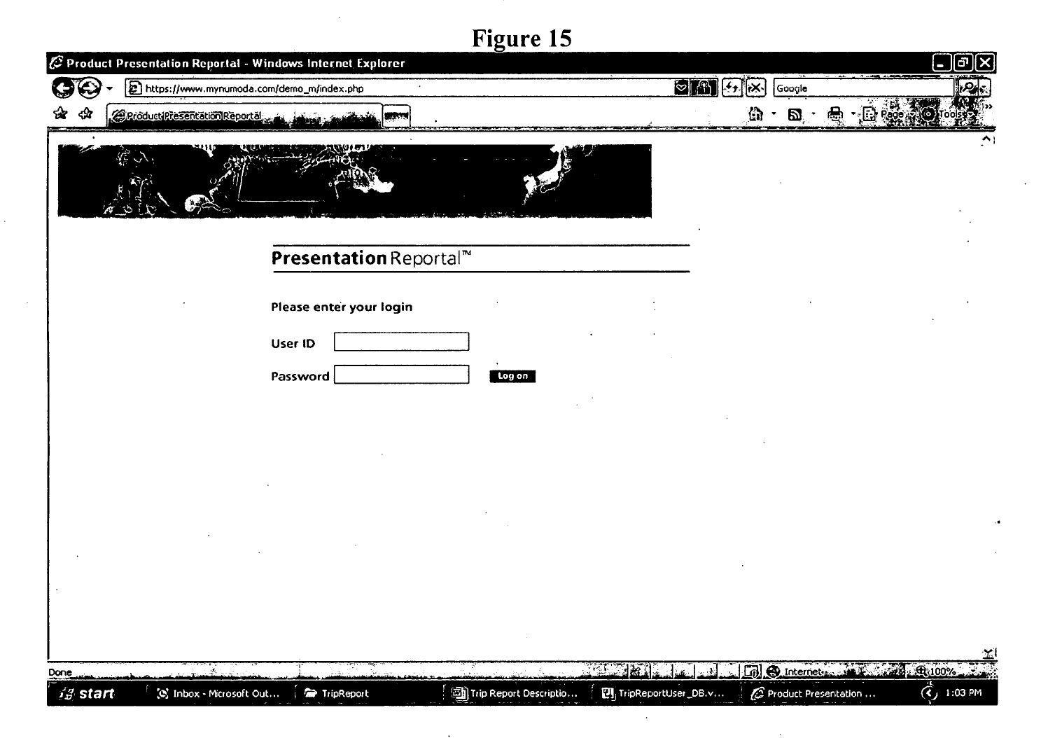

All data collected from this object is stored into Report Status table (tblSiteRptDoc) as shown in FIG. 15. Uploaded files are stored in server file system. Trip report files are retrieved by the file name in the database.

“Report Edit Object” uses 5 fields:

| | | |
|---|---|---|
| 1. PkIndex | integer | Primary key index |
| 2. Site | integer | Site Number |
| 3. Trip Type | char | Pre-Study, Initial, Routine, Closeout |
| 4. Trip Date | mon dd yyyy | Date of Visit |
| 5. Duration | float | Length of the visit in days |

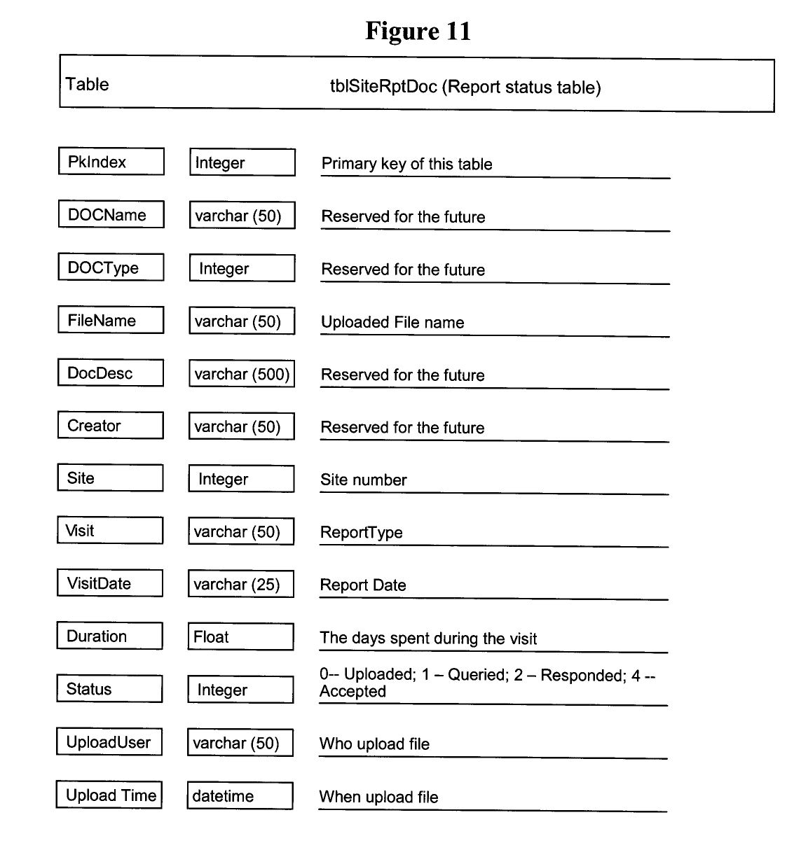

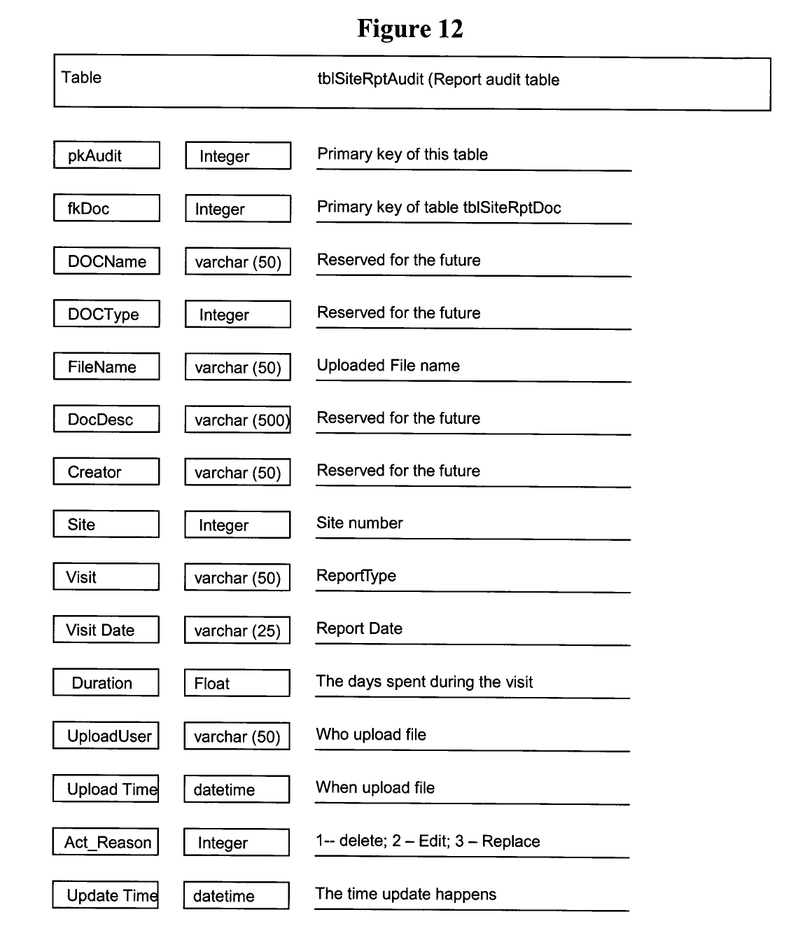

PkIndex is the primary key of the record in the Report Status table shown in FIG. 11. Any change made will have a log in Report Audit Table (tblSiteRptAudit) as shown in FIG. 12. Based on different user roles and regions defined in User Table, a user can generate his or her own view of trip report summary. The user can select site, time range and combination of report status to create a custom view.

“Report View Object” has 5 properties:

| | |
|---|---|
| 1. Country | char |
| 2. Site | integer |
| 3. Start Date | mm dd yyyy |
| 4. End date | mm dd yyyy |
| 5. Trip report Status | integer |

“Report View Object” has 6 fields to display in the view:

| | |
|---|---|
| 1. Country | char |
| 2. Site | integer |
| 3. Trip Type | char |
| 4. Trip Date | mon dd yyyy |
| 5. Duration | float |
| 6. Trip report Status | integer Uploaded, Queried, Responded, Accepted |

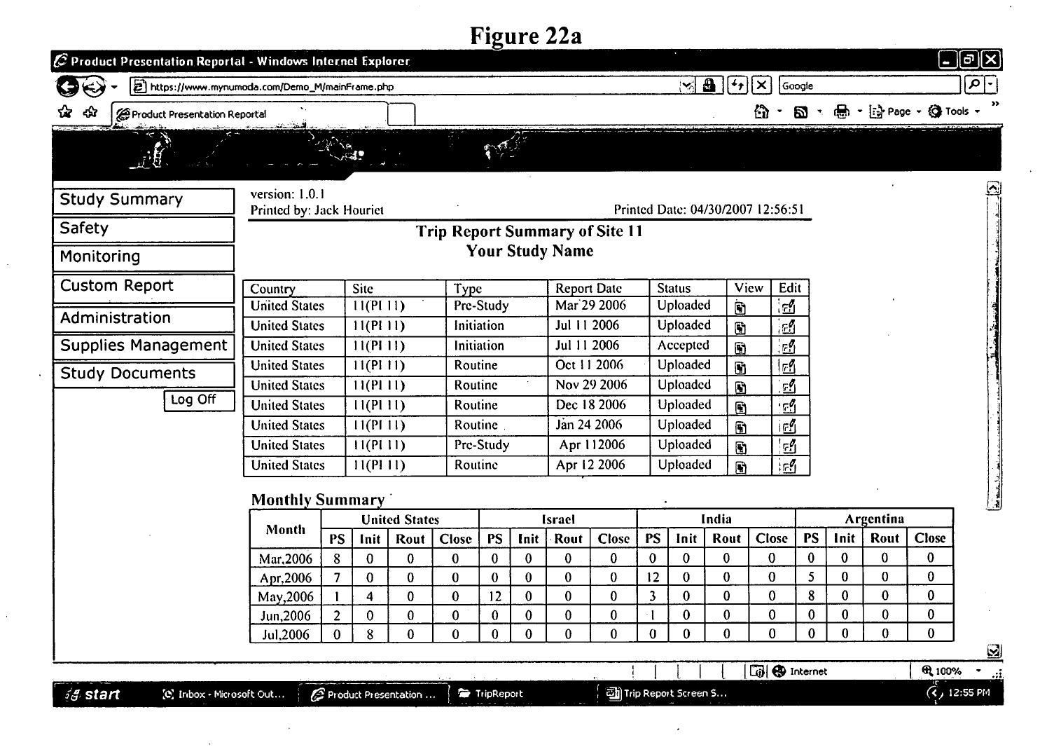

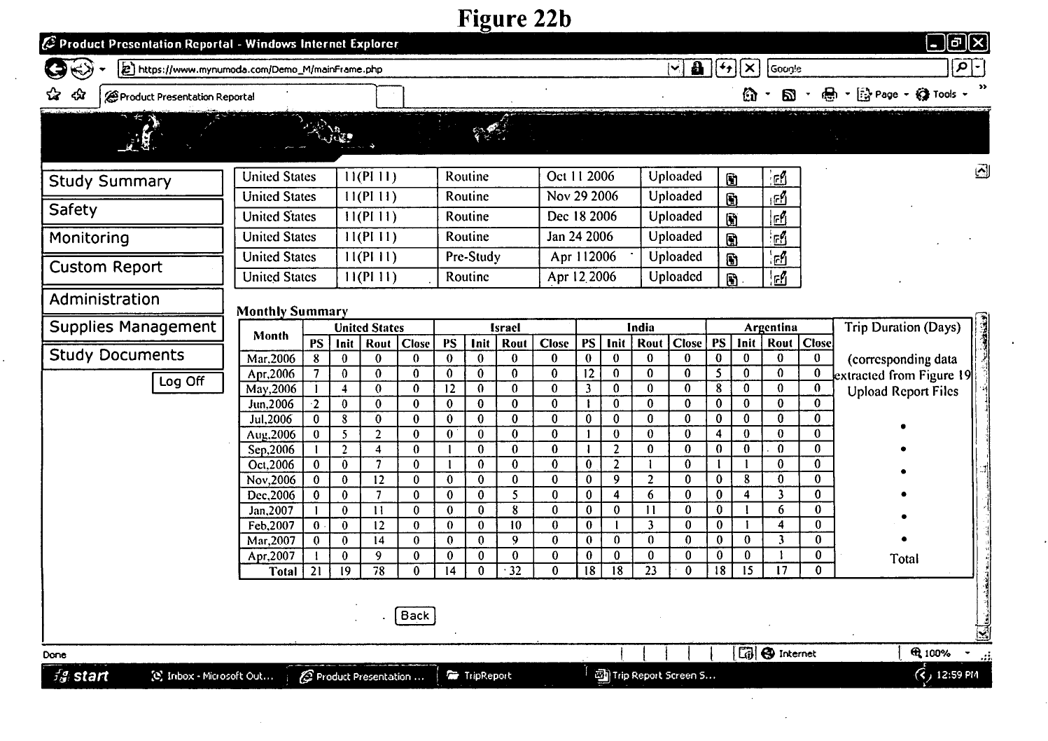

Examples of these report formats can be found on FIGS. 22a and 22b.

A user can view details of a trip report from the summary view and can access a modification tool if the user is not a Sponsor user type.

A monthly summary will be created at the same time. It presents the summary of monthly statistical total days for each region and visit. It also provides the sum of days for each region and visit.

“Monthly Trip Report” View has 1 property:

| | |
|---|---|
| 1. Month | char |

“Monthly Trip Report” has numOfVisit*numOfRegion fields.

If user enters trip report information in error, it can be edited or deleted.

“Report Edit Object” has 5 fields:

| | |
|---|---|
| 1. PkIndex | integer |
| 2. Site | integer |
| 3. Trip Type | char |
| 4. Trip Date | mon dd yyyy |
| 5. Duration | float |

PkIndex is the primary key of the record in the Report Status table.

Any change made will have a log in Report Audit Table(tblSiteRptAudit) as shown in FIG. 12.

After trip report is uploaded, manager or sponsor will review it. If they are satisfied with the report, they can accept the report. If they have question about it, they can issue a query. Another user will respond to the query and may solve the problem.

“Report Query Object” has 4 fields:

| | |
|---|---|
| 1. PkIndex | integer |
| 2. Query Text | char |
| 3. User ID | char |
| 4. User Pin | char |

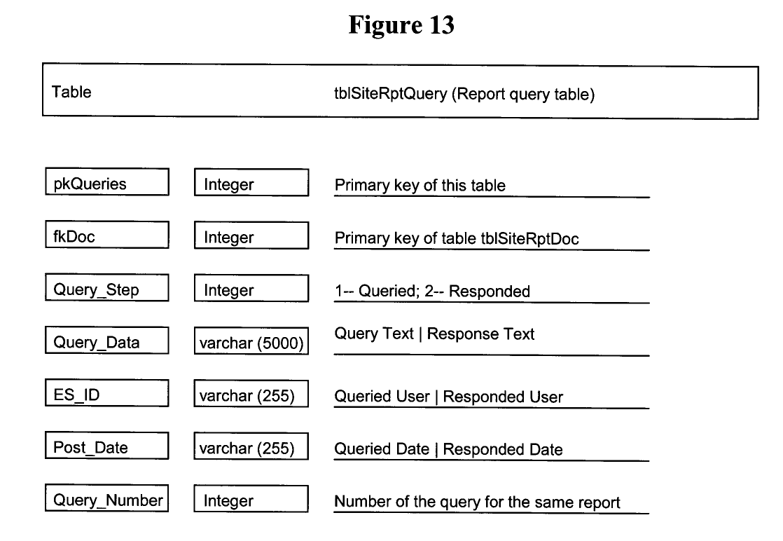

This object collects initial issued queries and responses for queries. All info is stored into Query table (tblSiteRptQuery) in the database as shown in FIG. 13.

There are four type of statuses for trip reports:

Uploaded—Trip report is uploaded to system, nobody has reviewed it yet
Queried—Somebody issue queries without response
Responded—All queries have been responded
Accepted—Satisfied in the very beginning or after all queries are responded

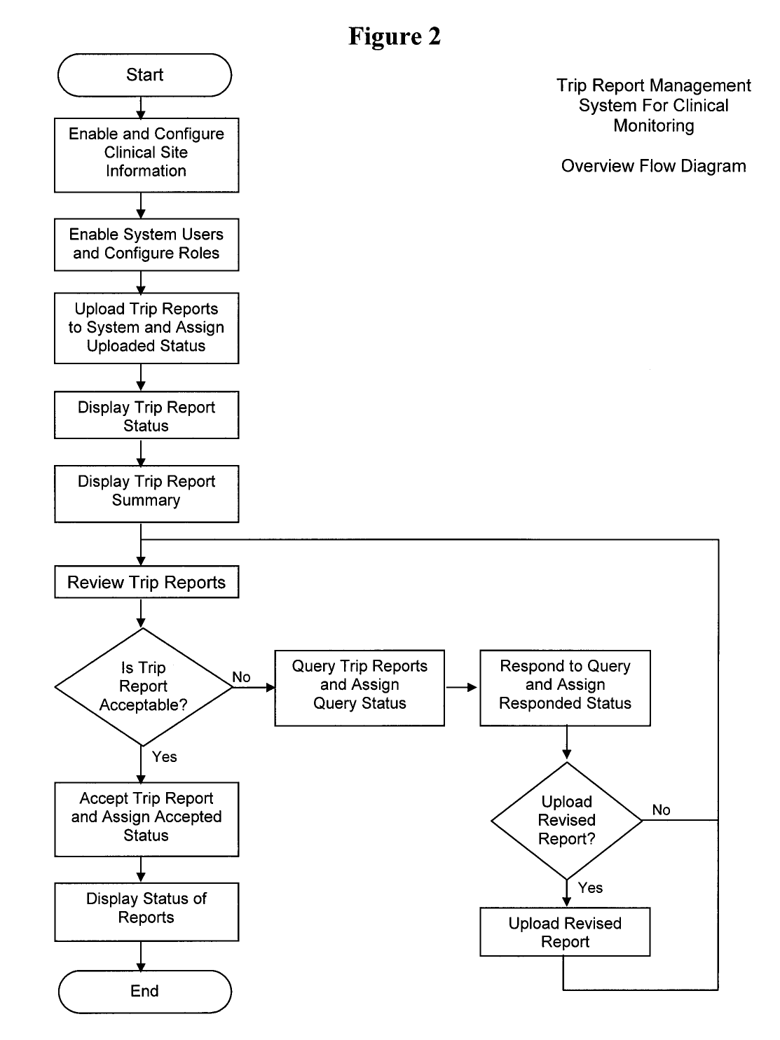

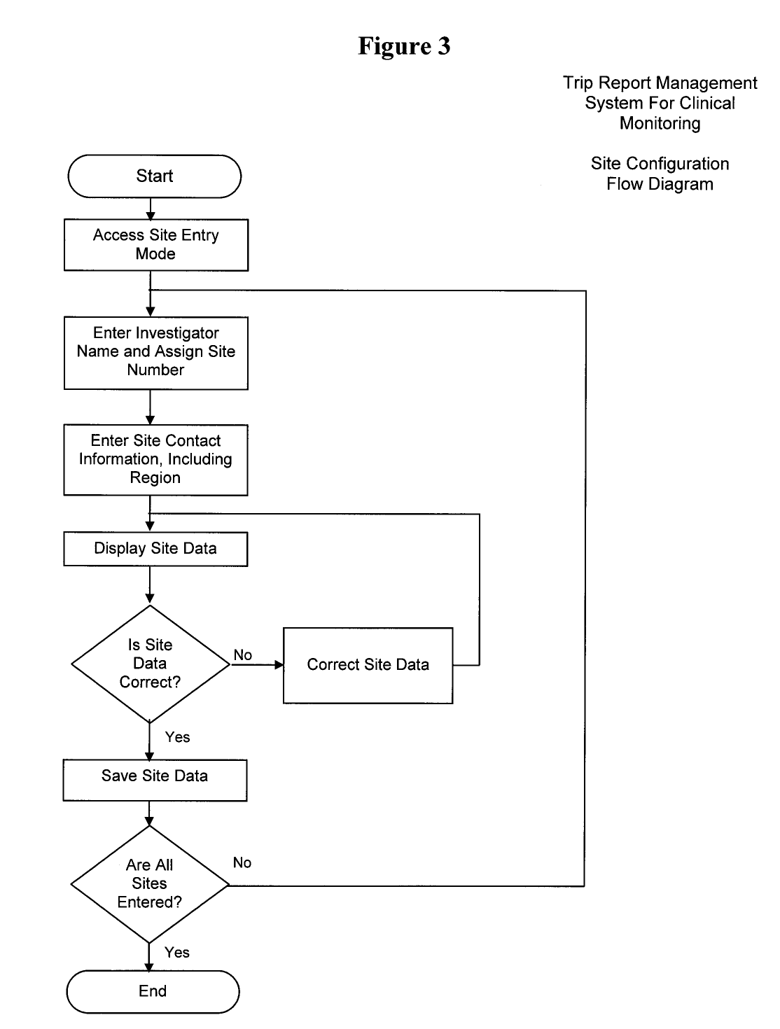

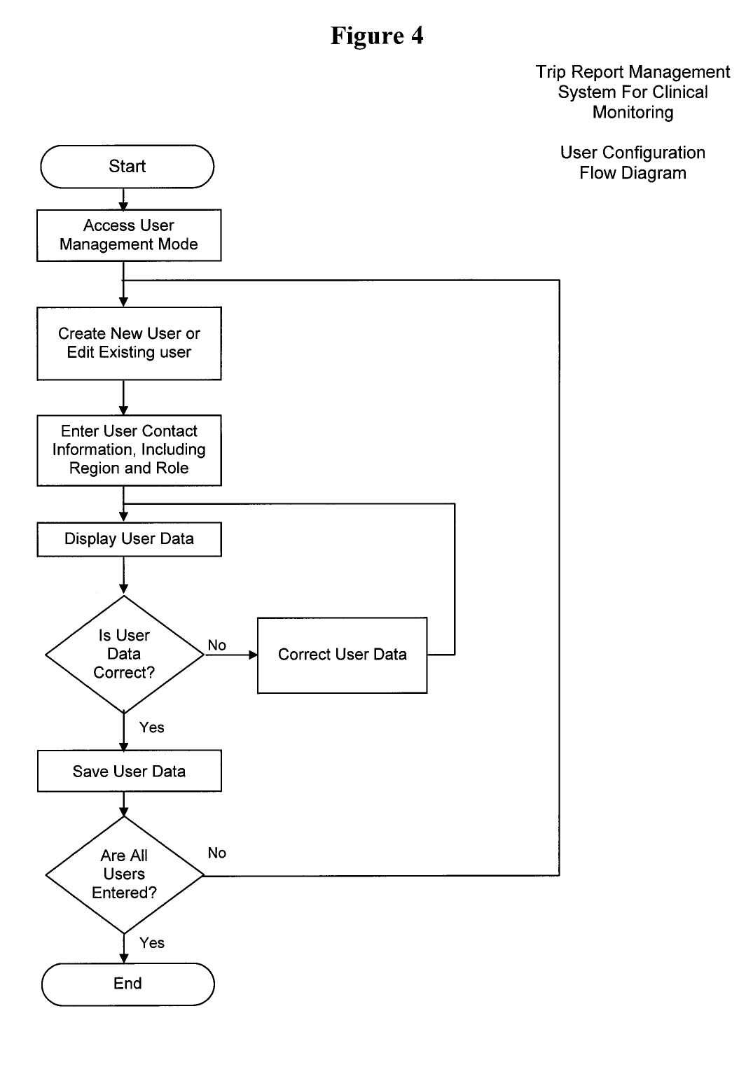

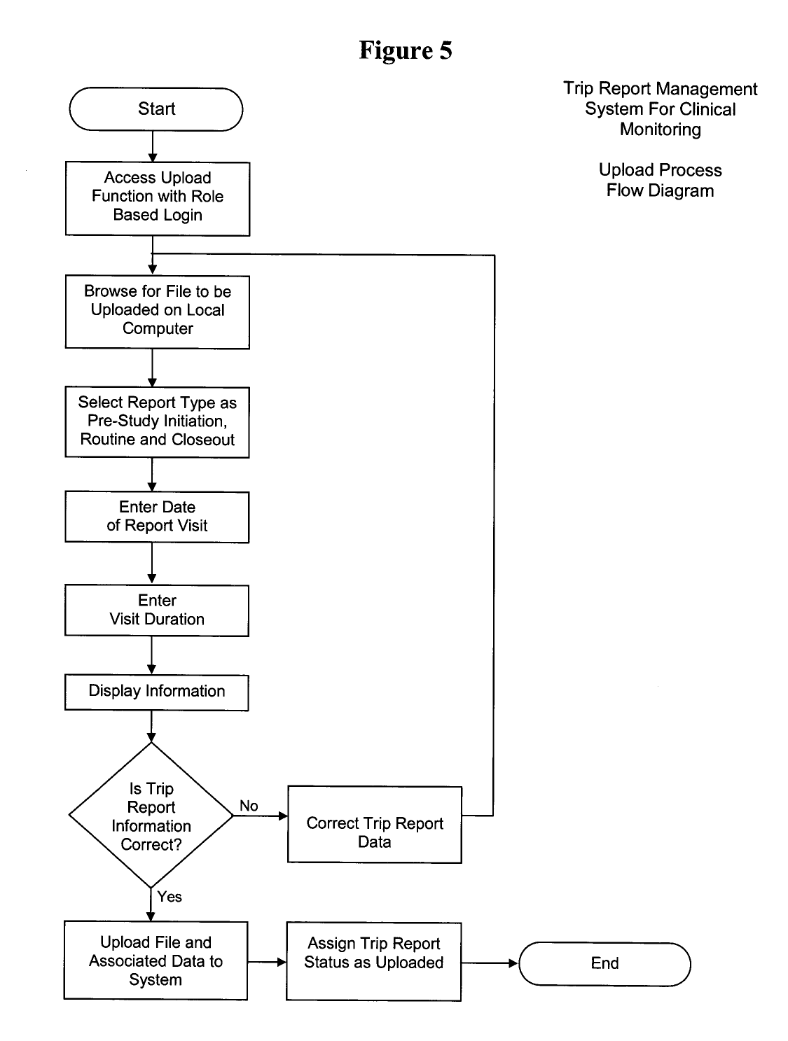

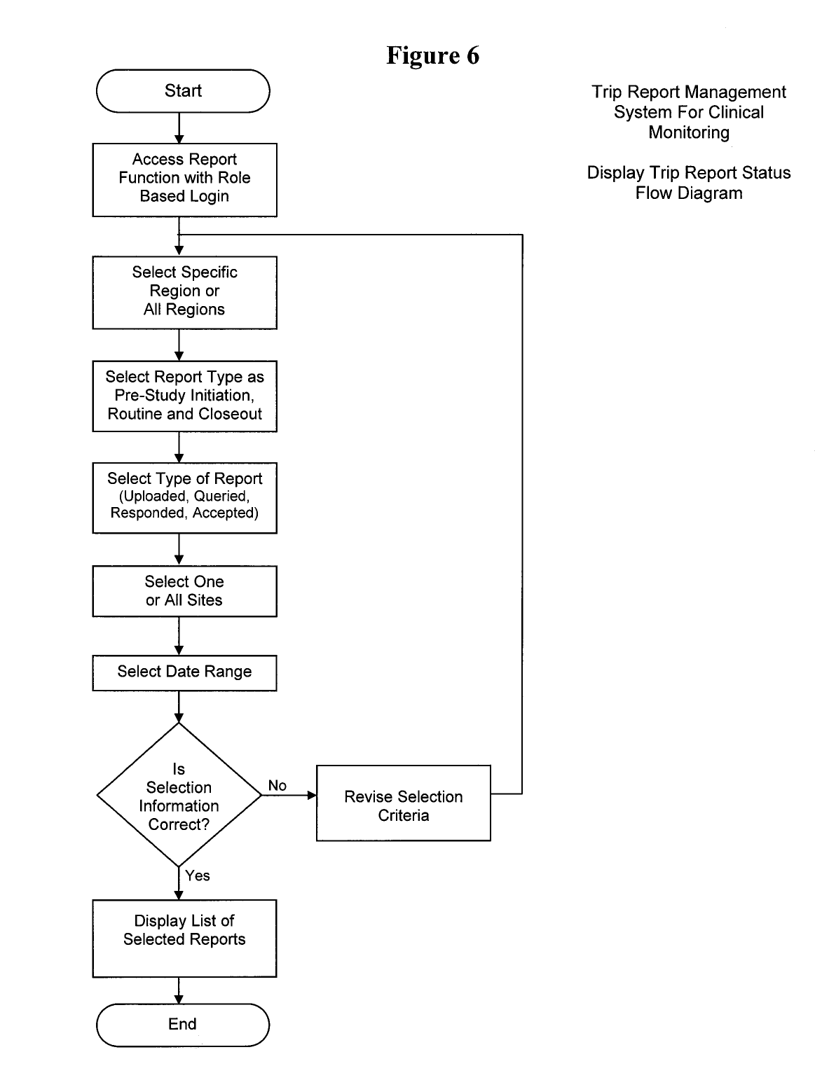

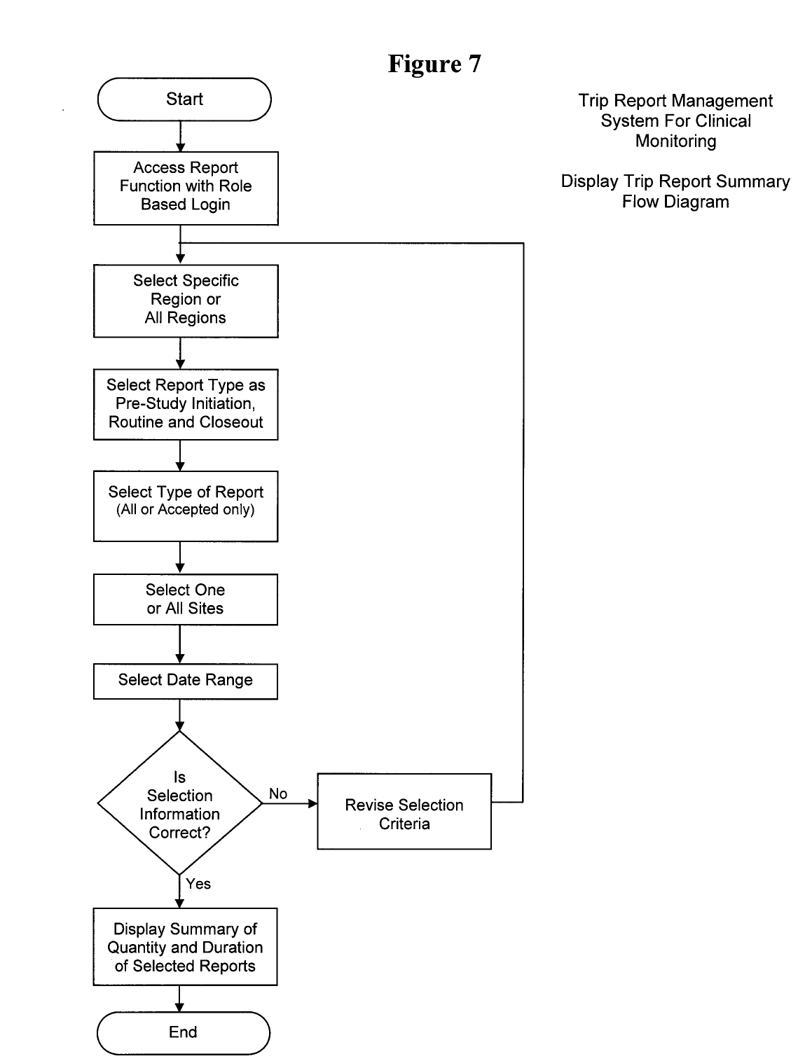

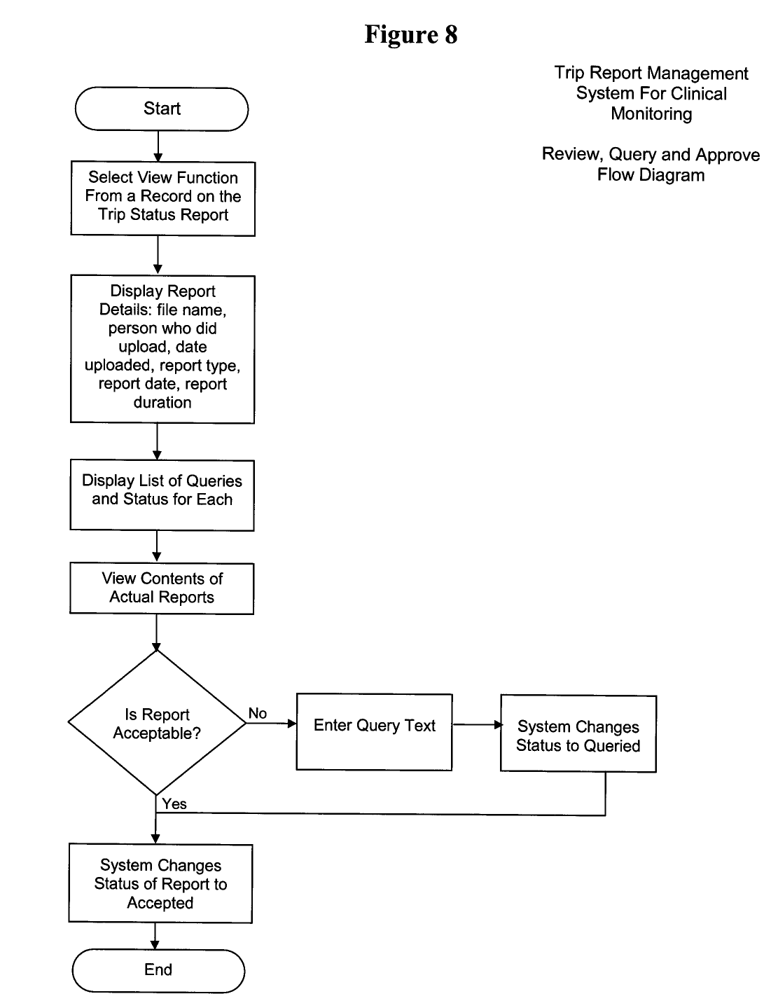

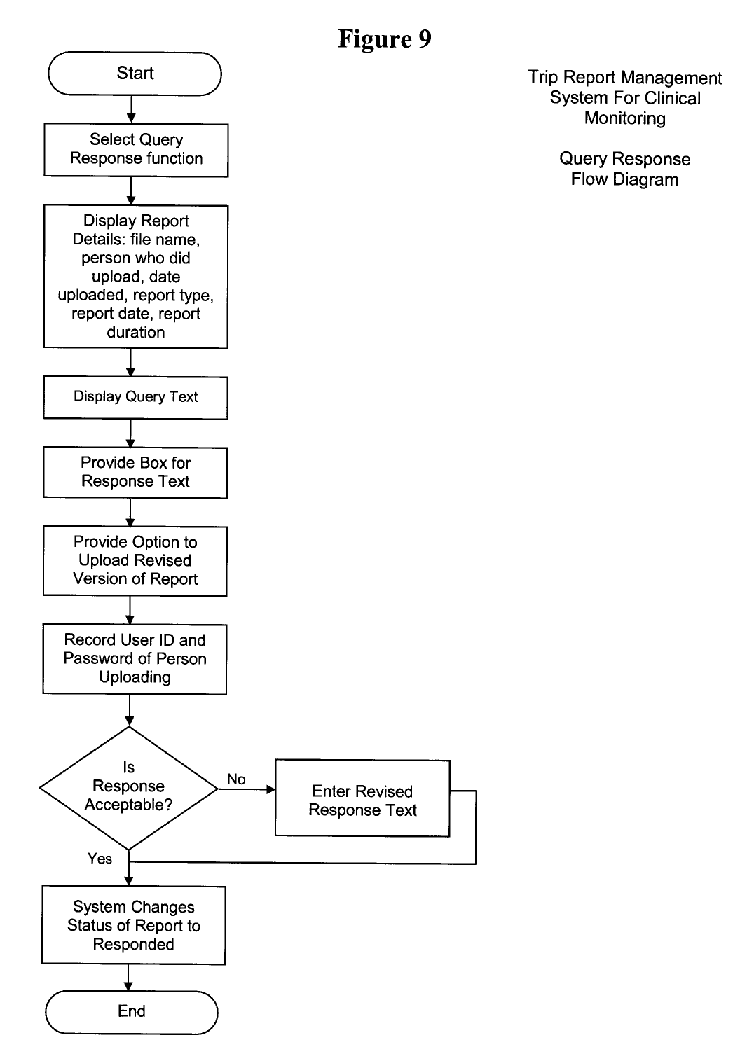

The steps outlined in FIGS. 2-9 show how the system is used. FIG. 2 shows an overview of the process, and FIGS. 3-9 detail the steps depicted in FIG. 2.

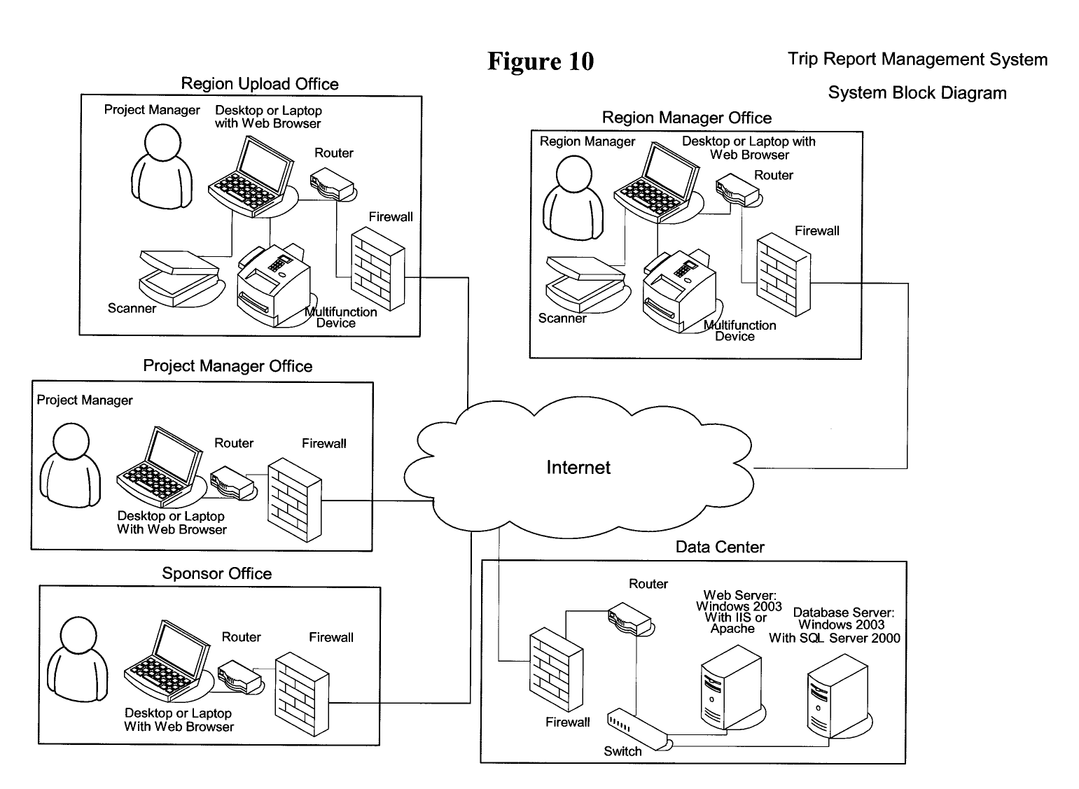

The hardware used to implement the current embodiment is commercially available computing equipment, and may use any manufacturer or operating system capable of supporting a web-browser, a document-scanning device, supporting a secure connection to the Internet and running a database application. An example of a typical hardware configuration is shown in FIG. 10.

### Example of Use

Users configured, visit made, trip report completed, report uploaded, report reviewed, and the like.

To use the system, the initial hardware configuration described in FIG. 10 must be in place, and the software the runs the Trip Report Management System for Clinical Monitoring must be installed on the web server and database server shown in FIG. 10.

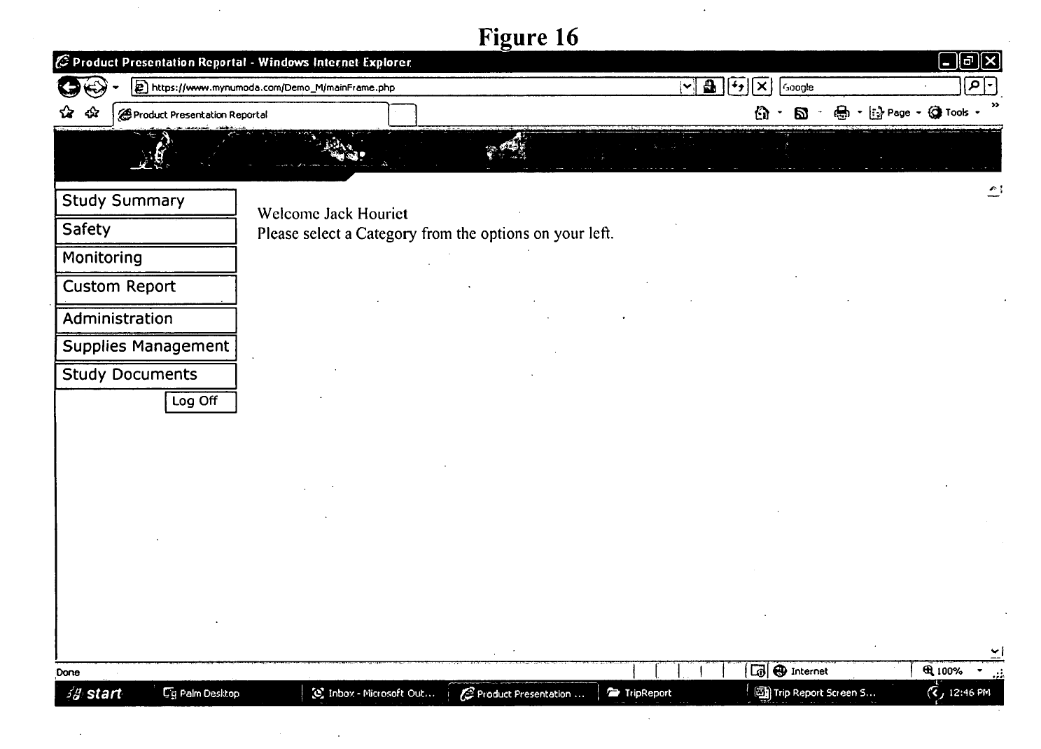

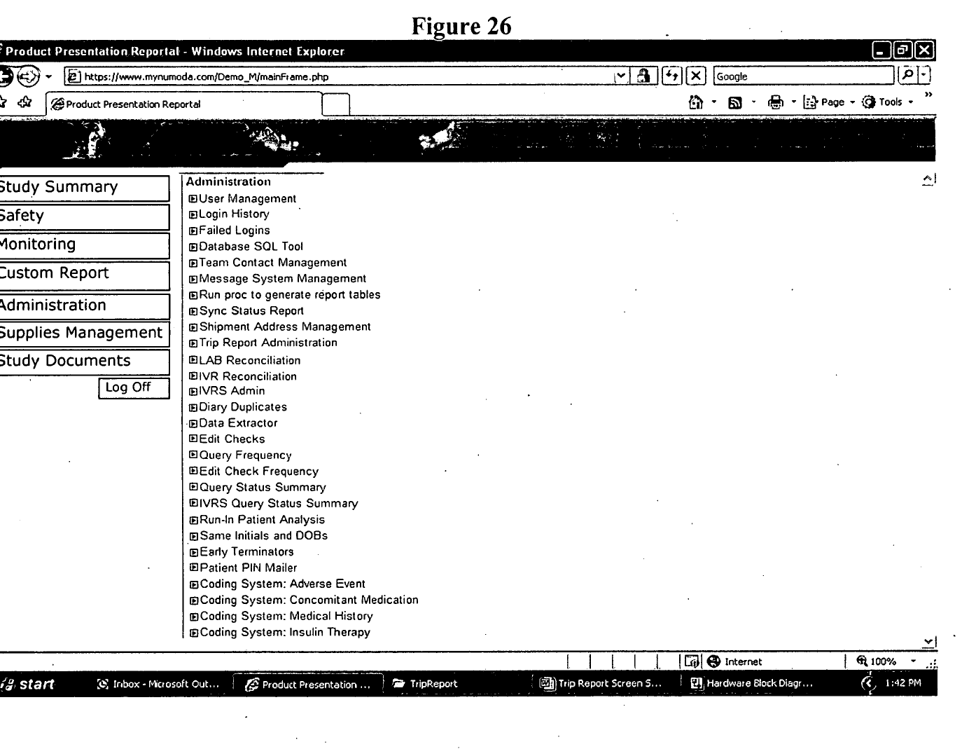

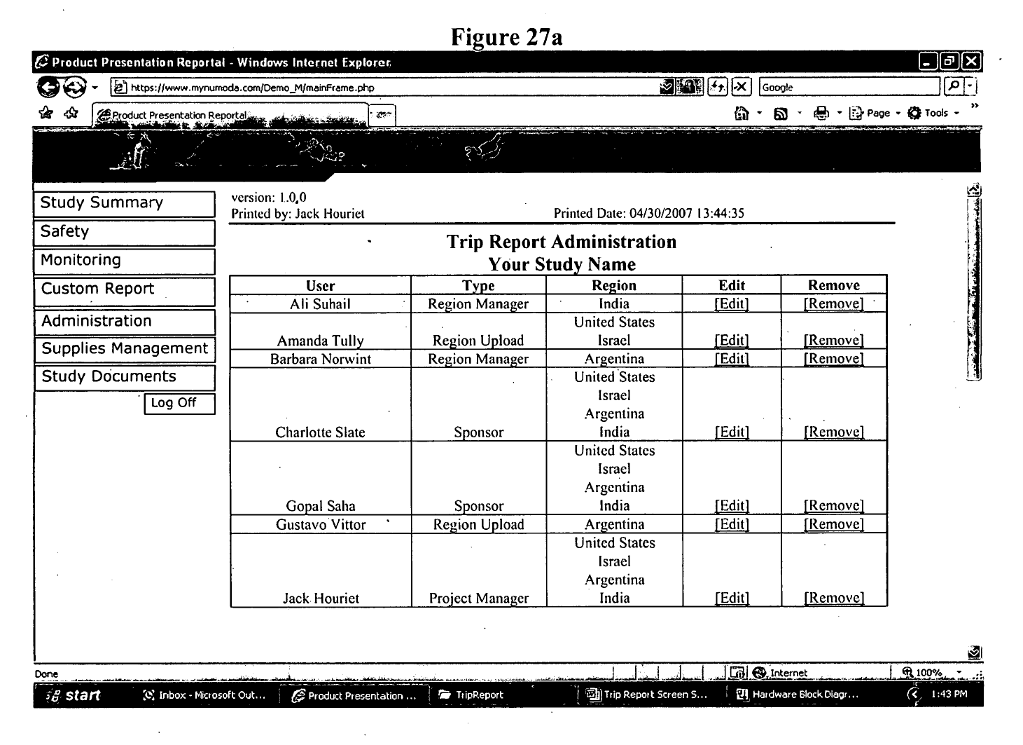

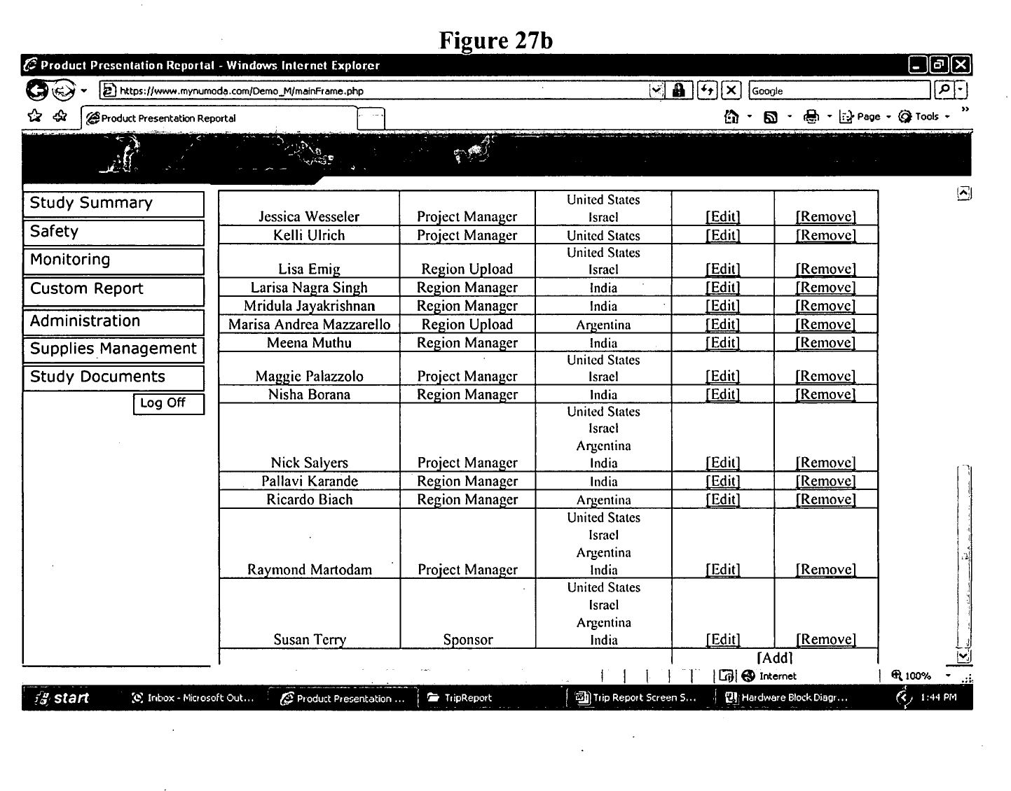

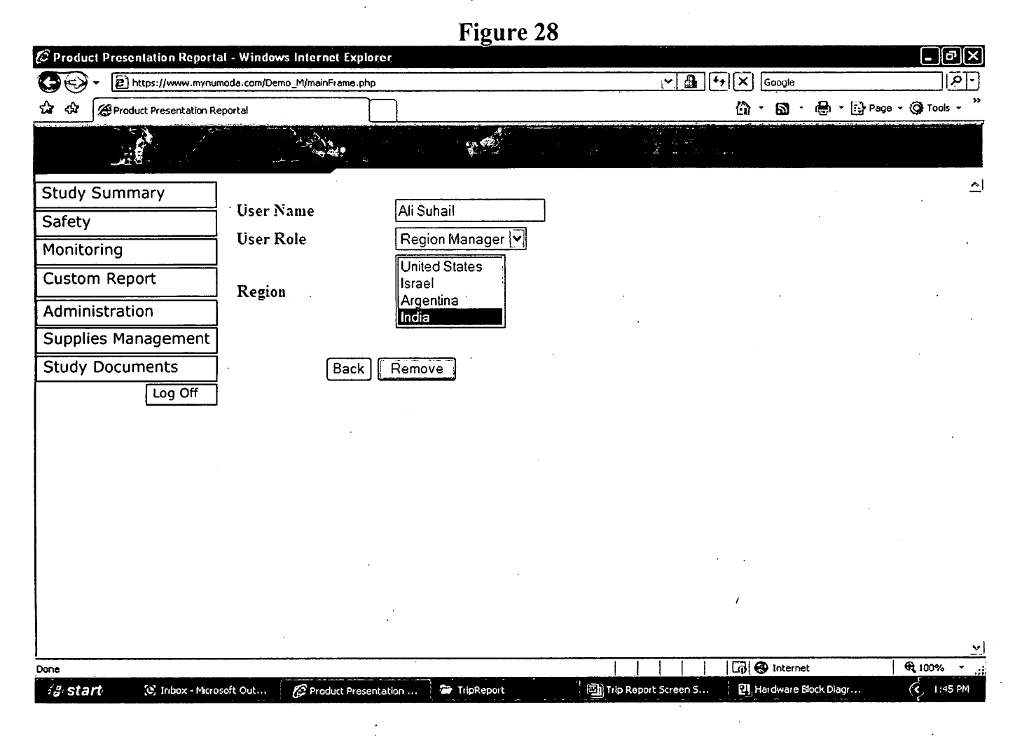

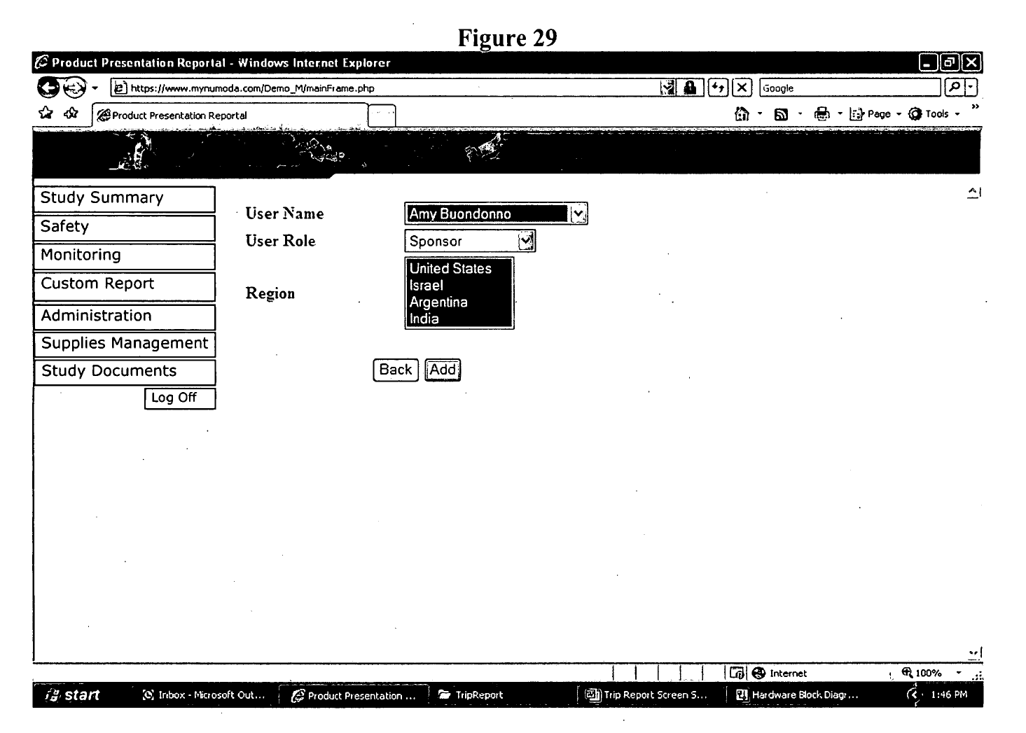

A user with Administrative rights can login to the system (FIG. 15) and select the Administration function from the menu (FIG. 16). The administrator then selects the Trip Report Administration function from the administrative menu (FIG. 26) to display the user administration functions for the Trip Report System (FIGS. 27a and 27b). The administrator will then select the Add function (FIG. 27b) to access the Add screen (FIG. 29) The user can be selected, the role can be selected, and the region(s) can be established for that user. If a user needs a change in role or needs to be deleted from the system, the administrator can select the Edit function (FIG. 27a) and make the changes as needed (FIG. 28). The above steps will be performed to establish the user accounts for each of the different roles of users, and assigns the role of Sponsor, Project Manager, Region Manager, or Region Upload to each user. Once the users have been entered into the system, it is ready for use.

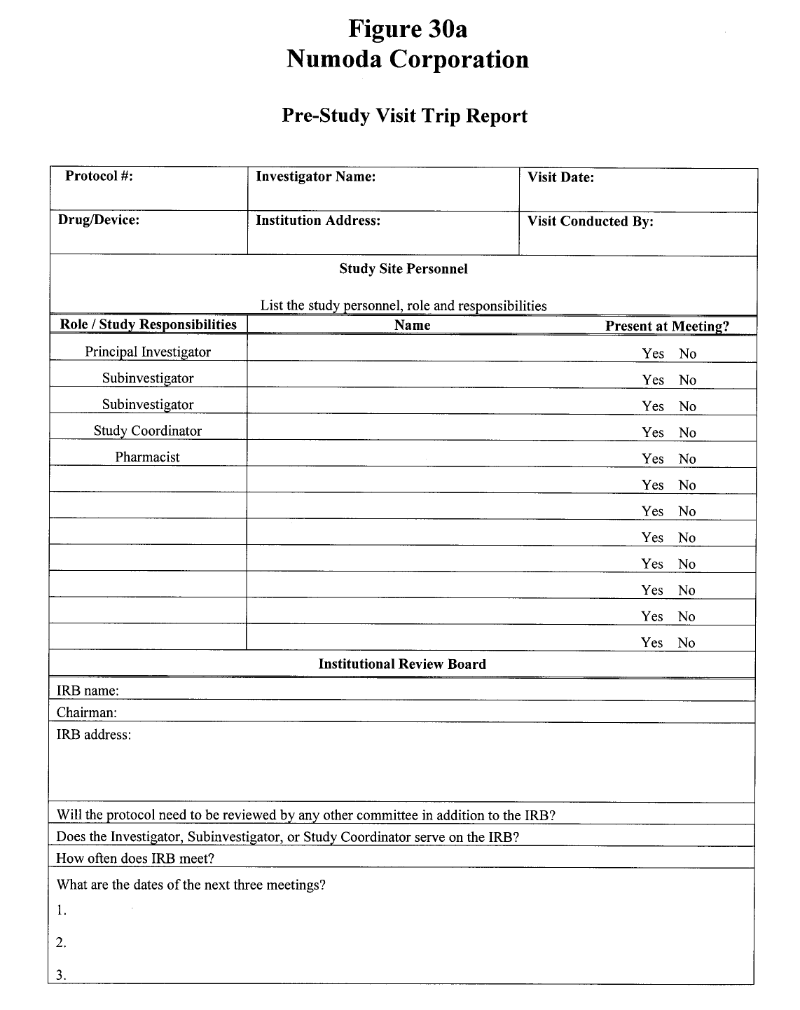

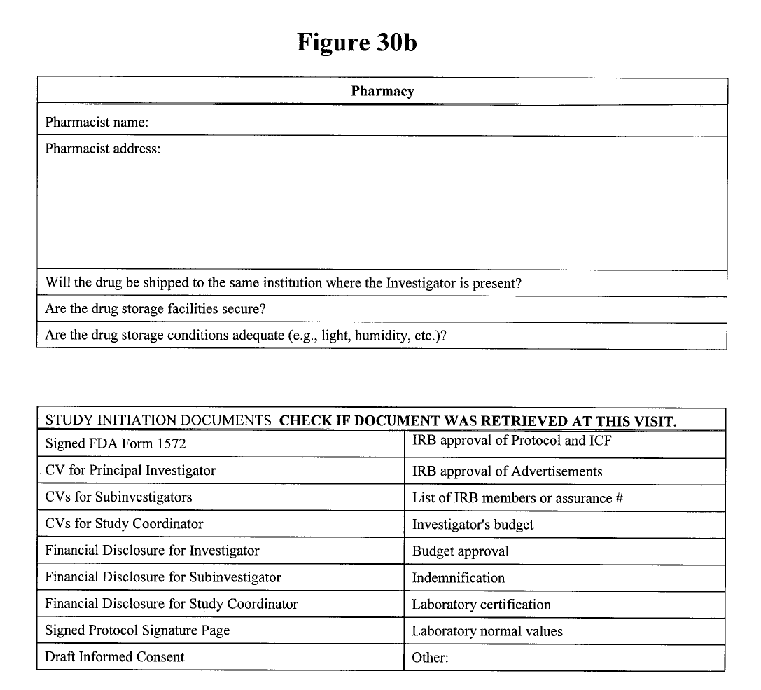

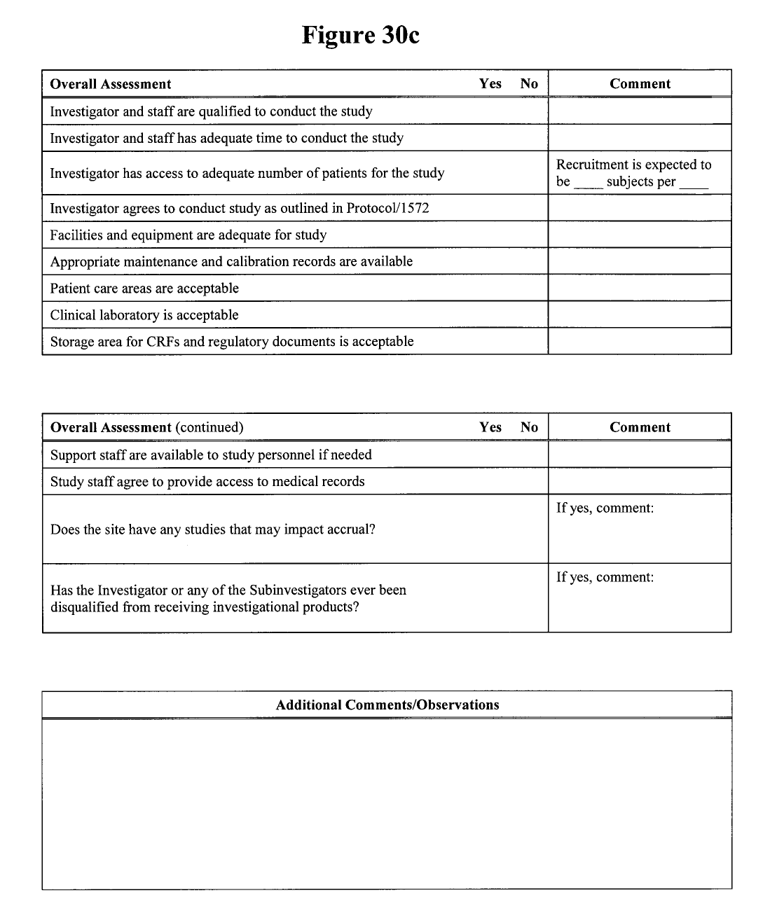

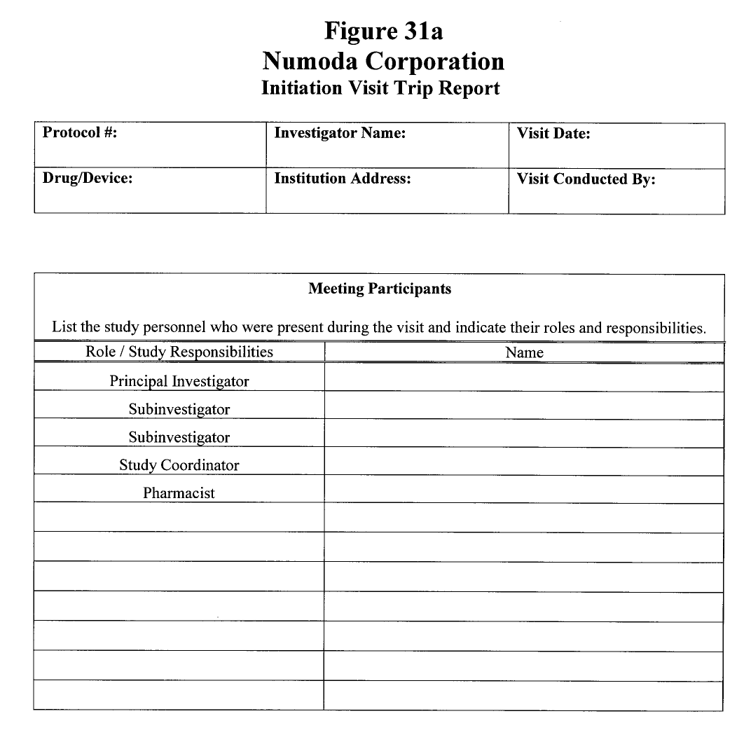

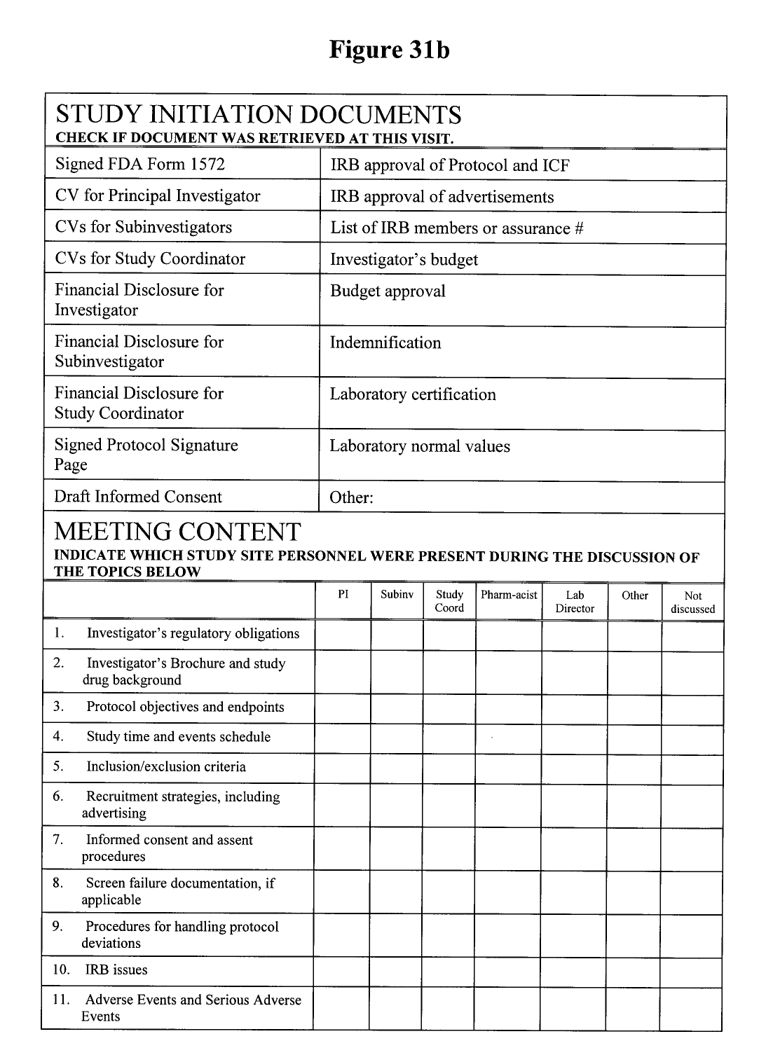

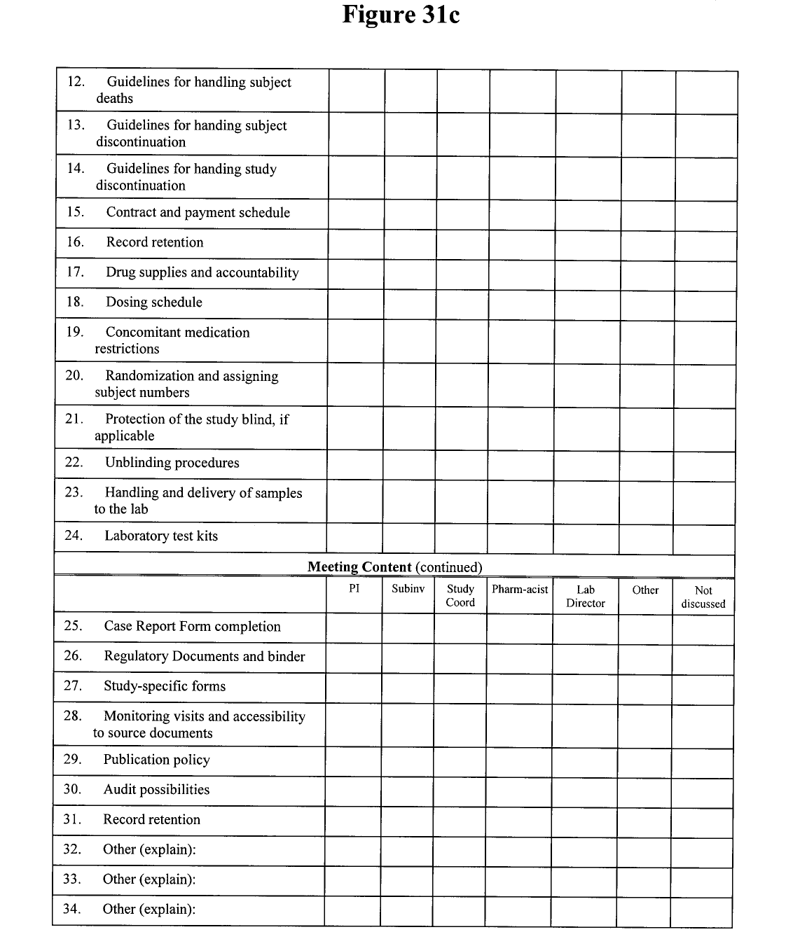

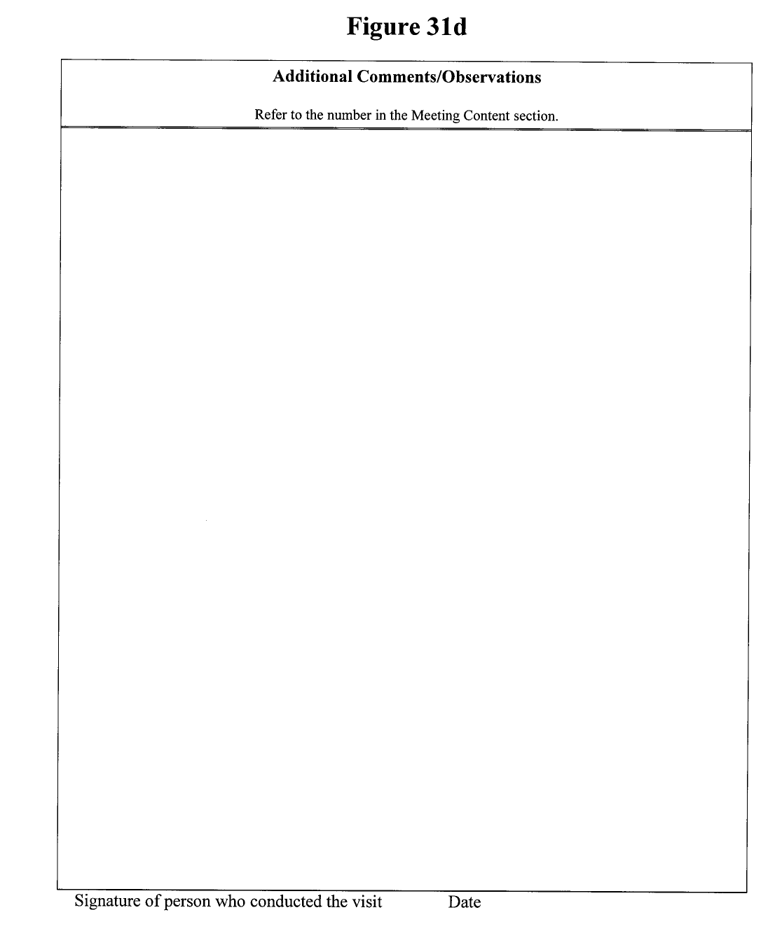

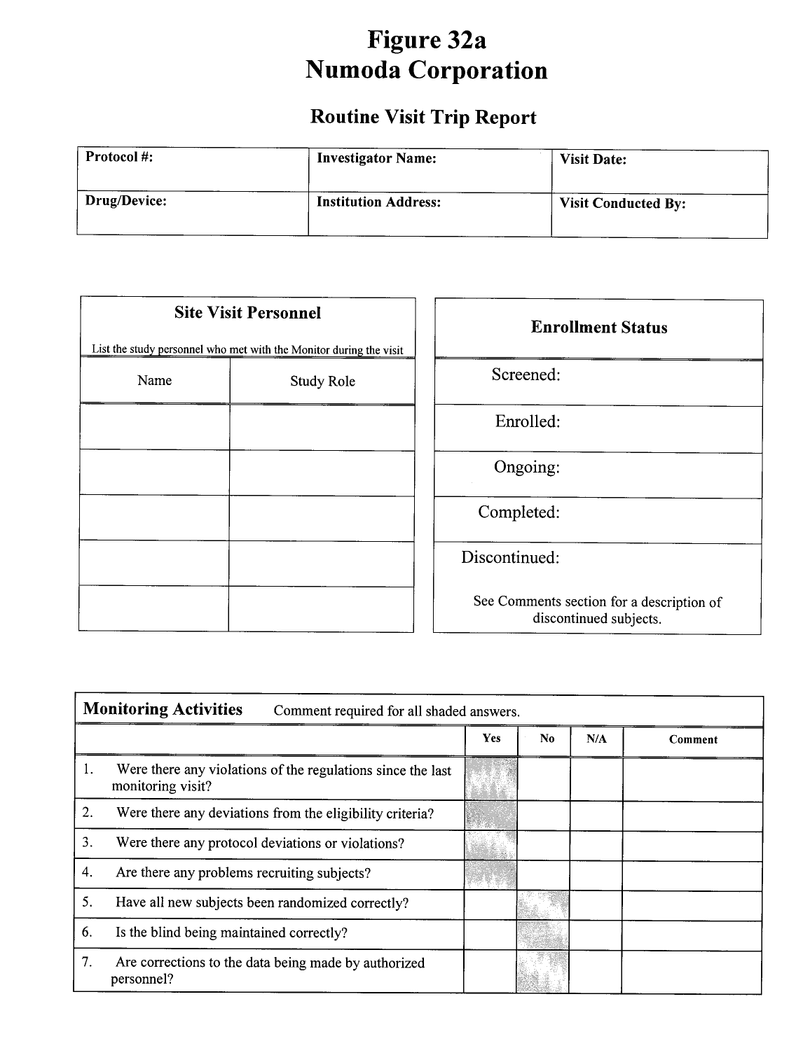

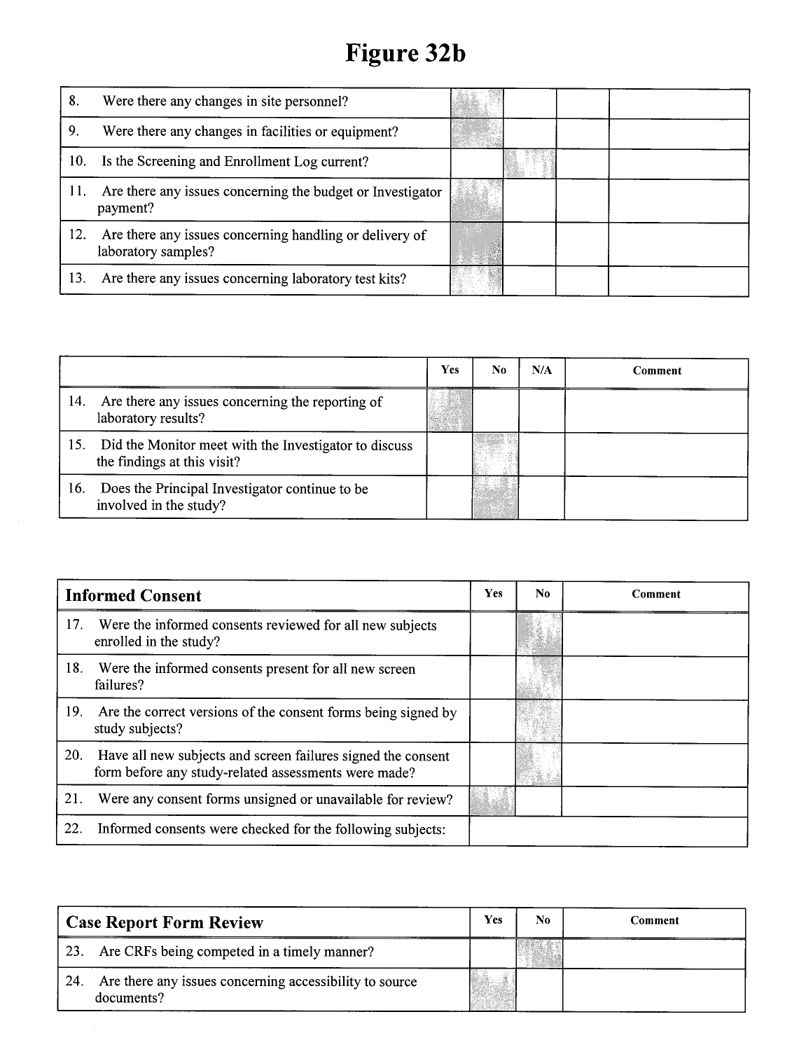

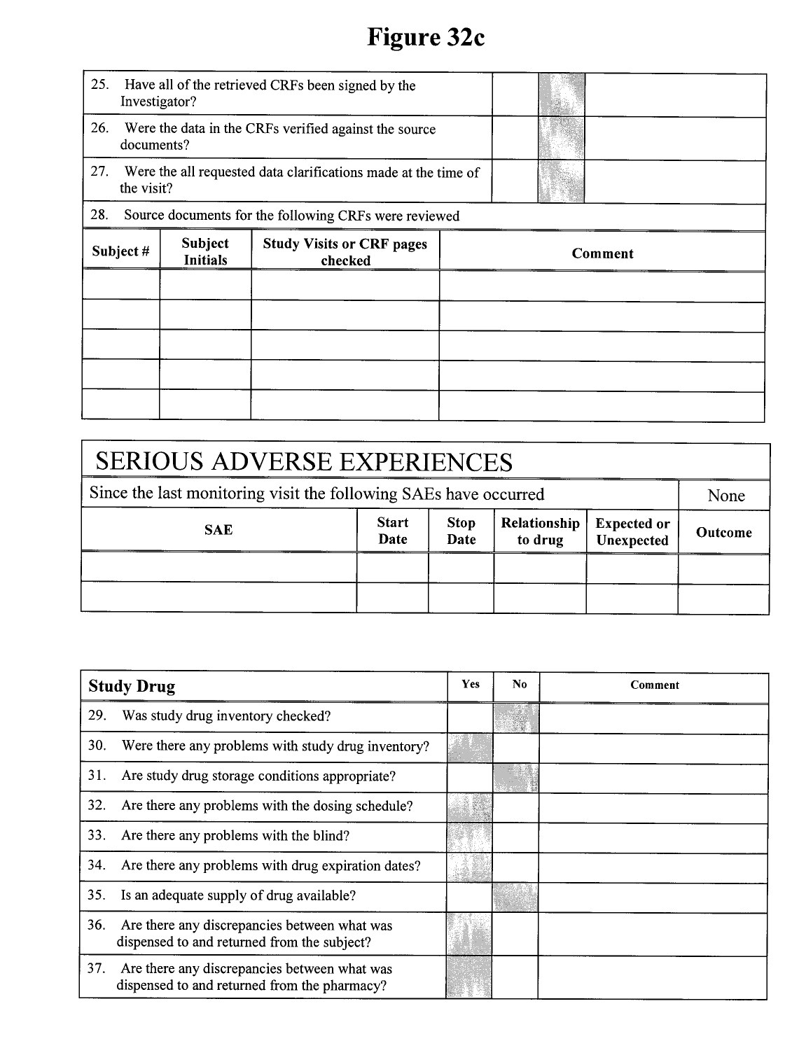

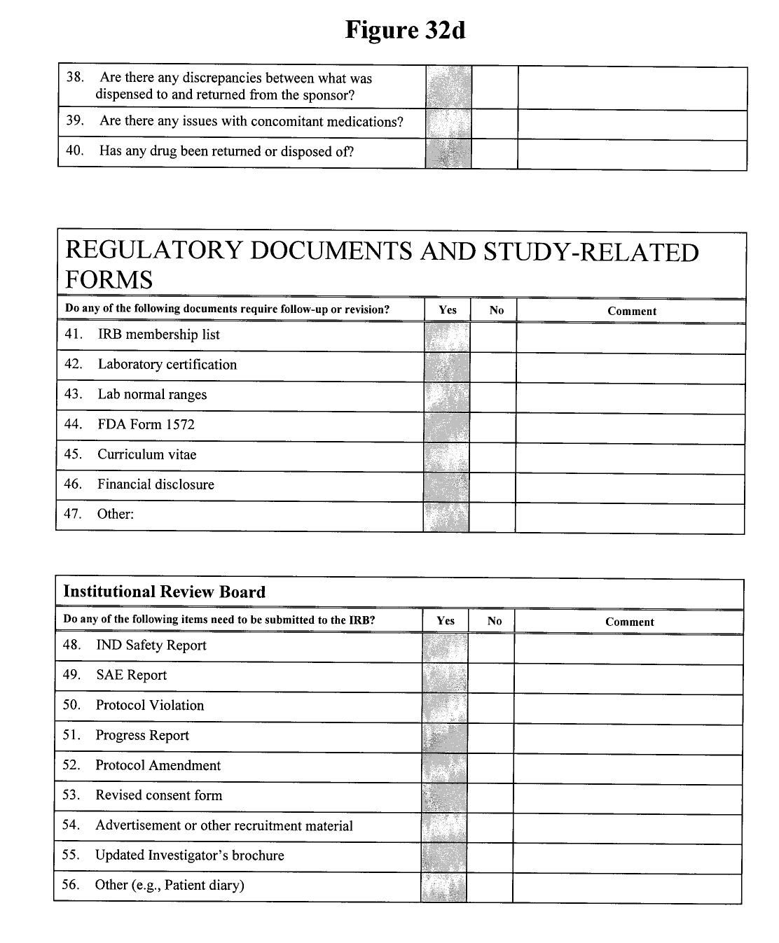

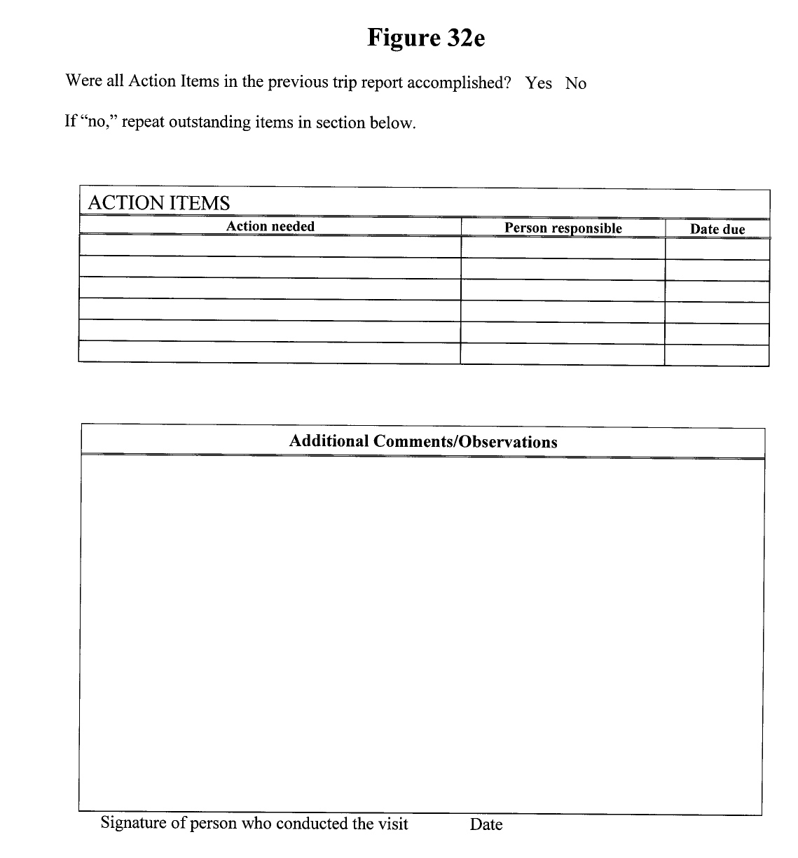

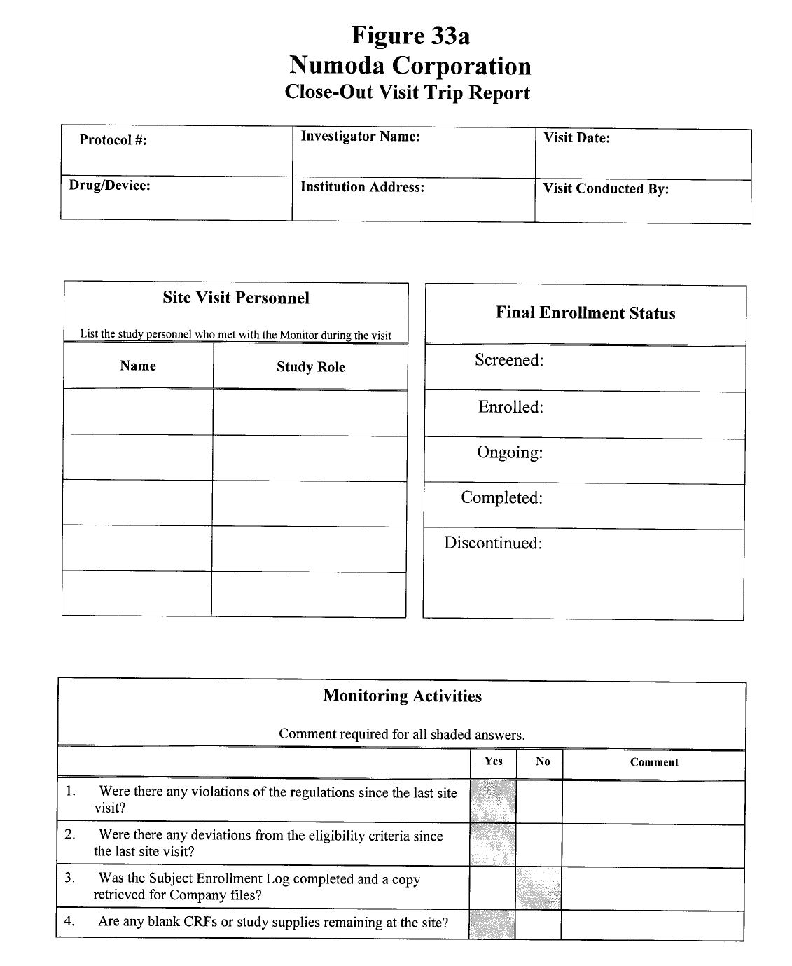

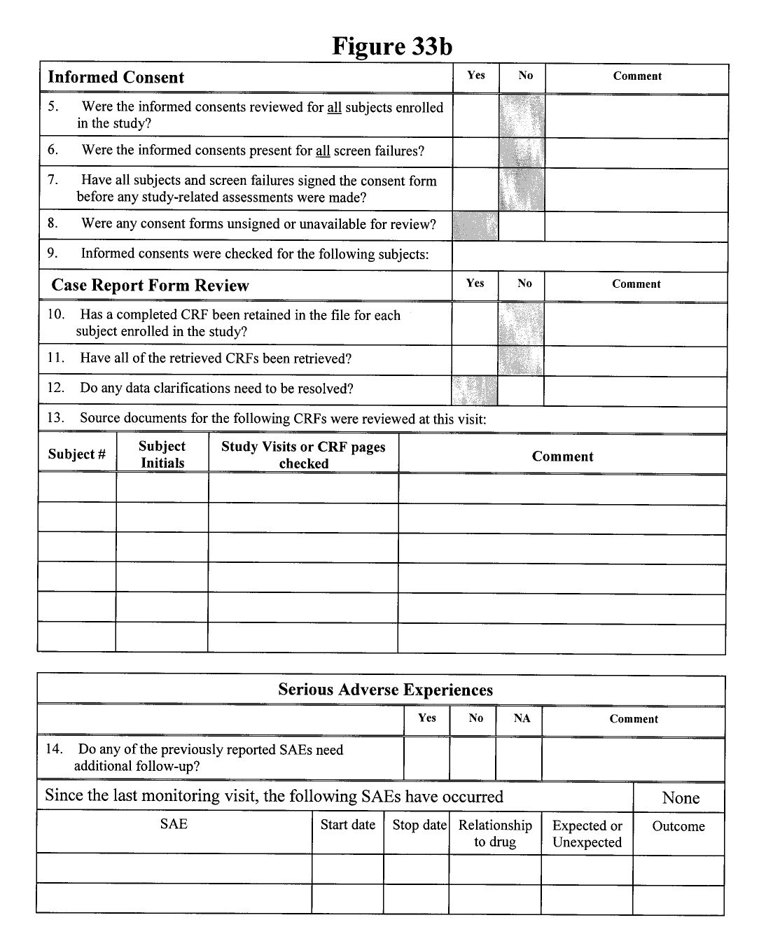

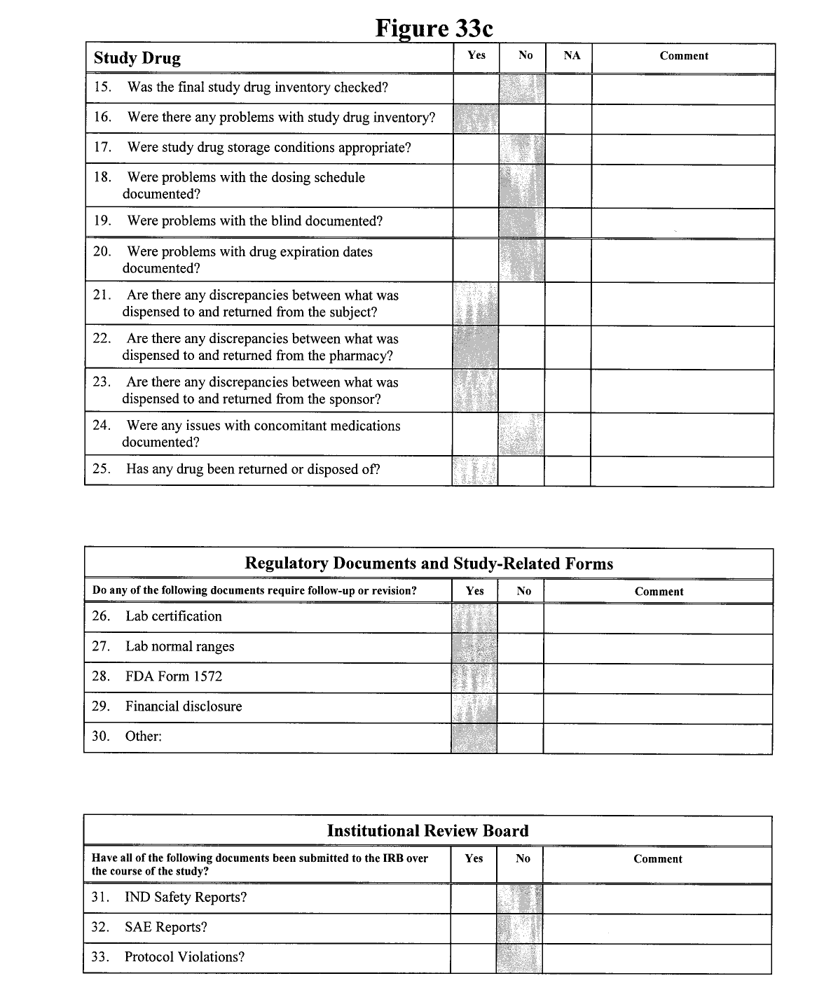

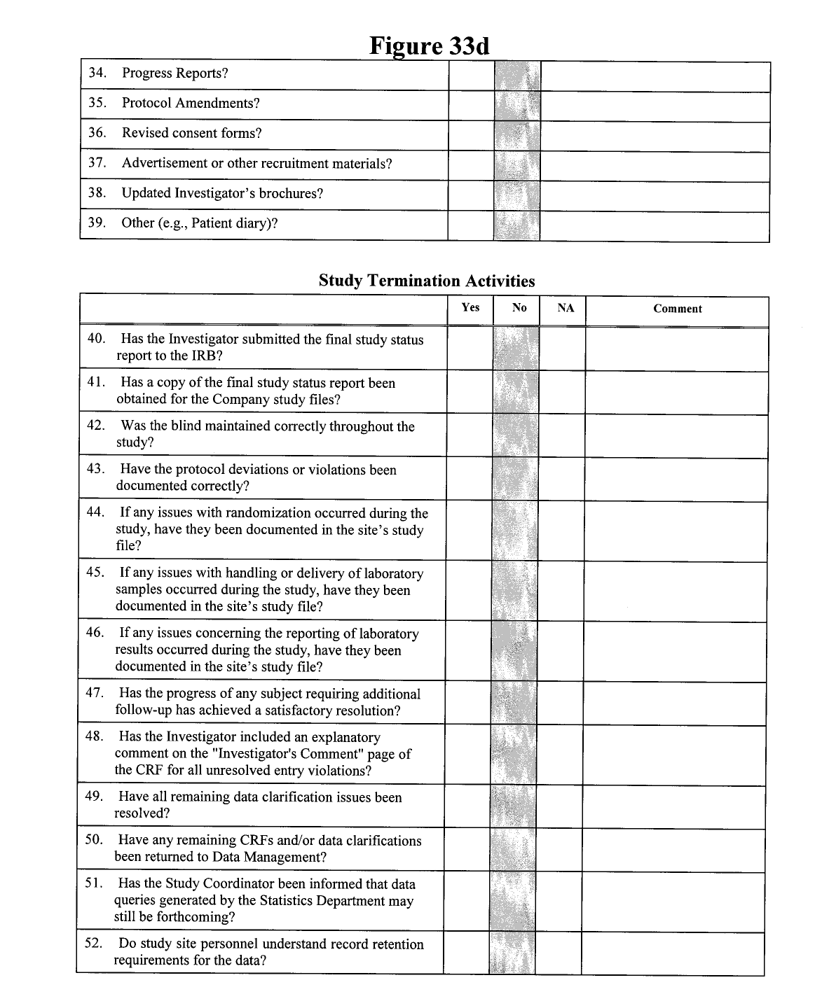

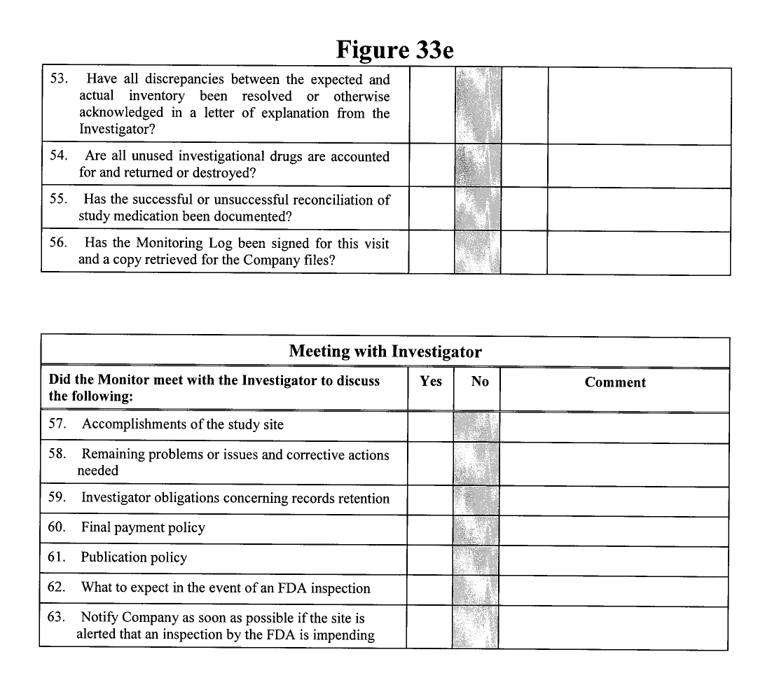

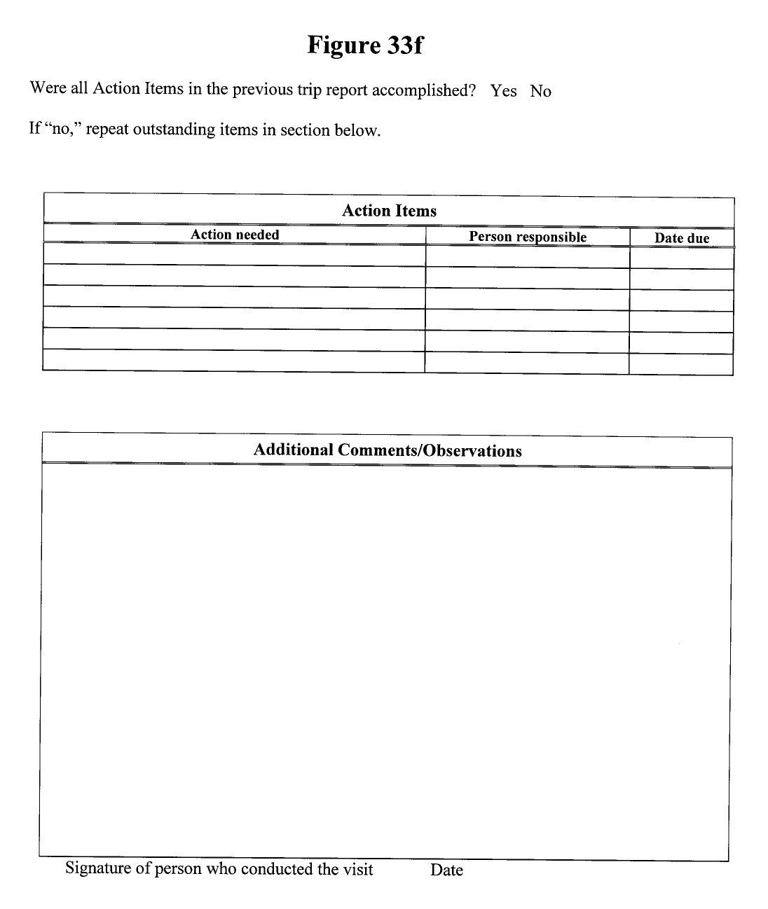

The next step in the process will be for a Clinical Monitor or CRA to make a visit to a Clinical Site. Once the visit is complete the CRA will create a visit trip report as required by the standard operating procedures of their employer. Examples of the trip reports are Pre-Study (FIGS. 30a, 30b and 30c) Initiation (FIGS. 31a, 31b, 31c, and 31d) Routine (FIGS. 32a, 32b, 32d, and 32e) and Close-Out (FIGS. 33a, 33b, 33c, 33d, 33e and 33f). These report titles are typical names used in the industry but could be called by other names to represent the specific work practices of a CRO. The CRA, or other person, can scan a copy of the report to their local computer as shown in the hardware diagram (FIG. 10).

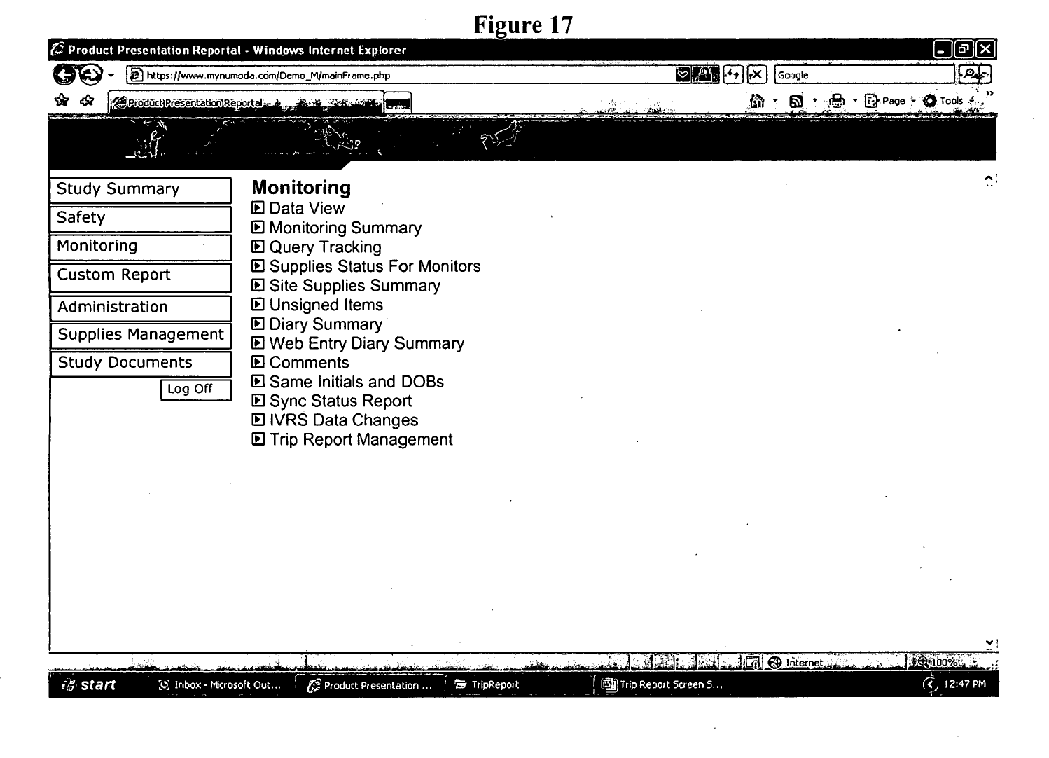

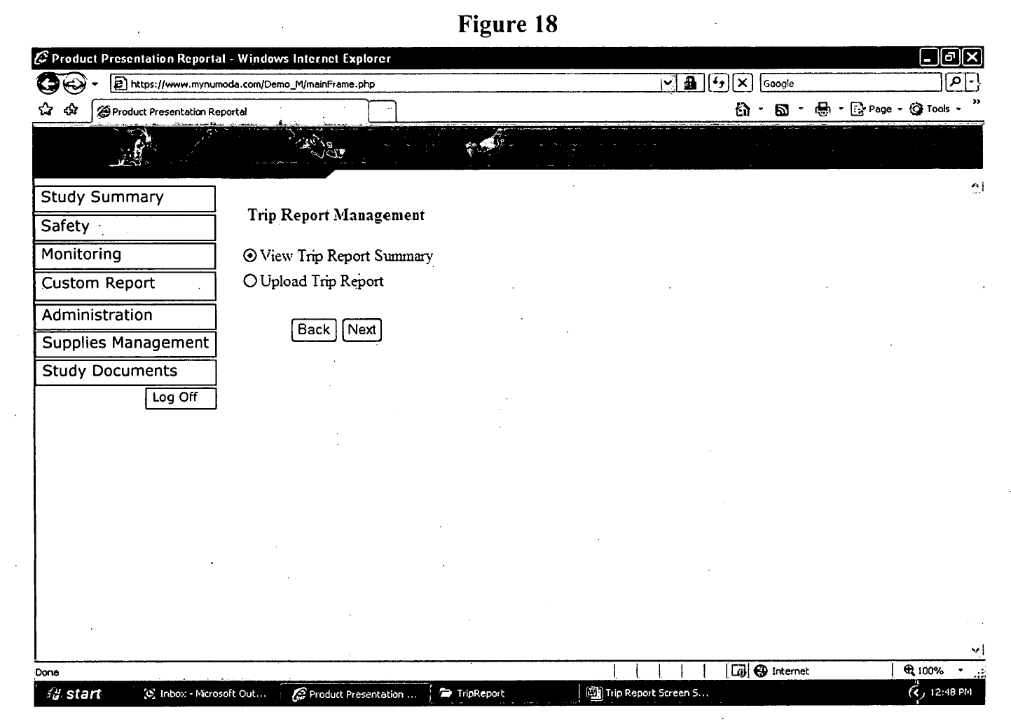

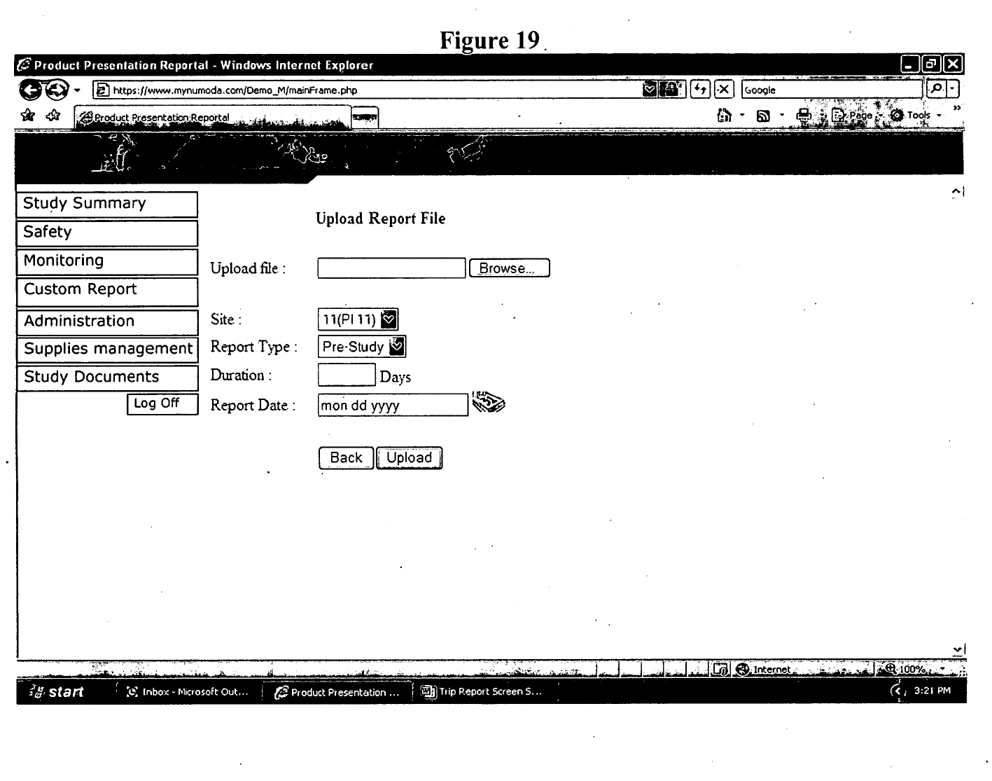

Once a trip report has been completed, it is ready for upload into the system. A Region Upload user logs into the system (FIG. 15) chooses the Monitoring menu choice (FIG. 16) and selects the Trip Report Management function (FIG. 17). The user then selects the Upload Trip Report function (FIG. 18). From the Upload Report File screen (FIG. 19) the user will browse for the location of the scanned trip report document, select the number of the site visited to generate the report, select the report type, enter the duration of the visit in days, and enter the date of the visit itself. Once these items are correct, the user can select the Upload button to save the report and associated identifiers in the database on the database server (FIG. 10).

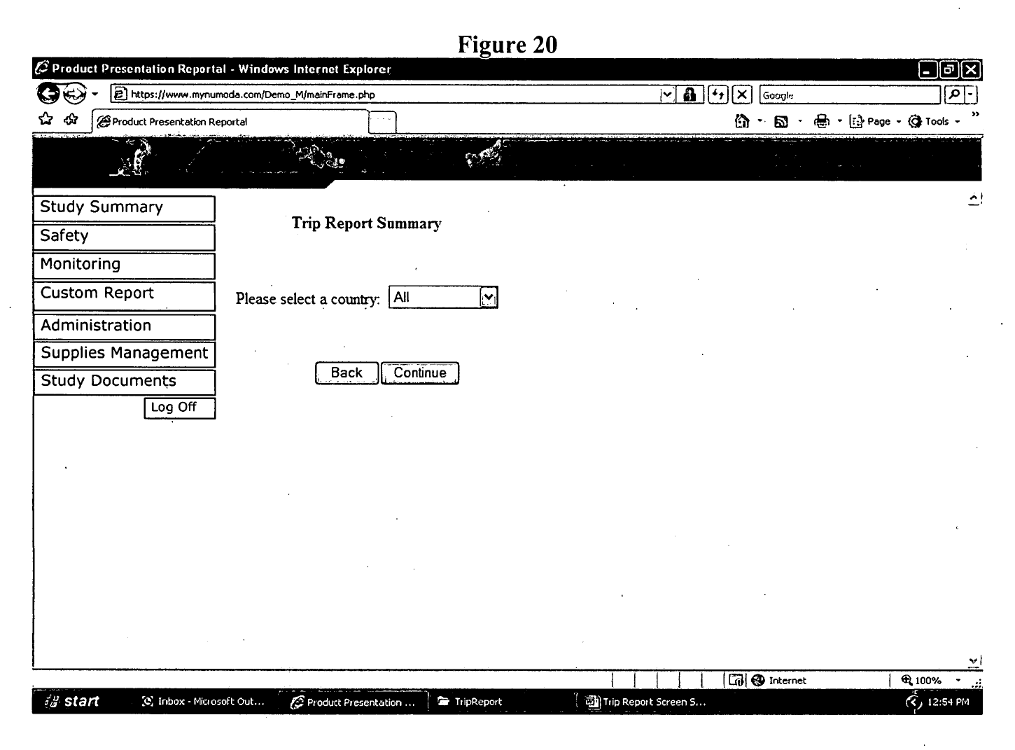

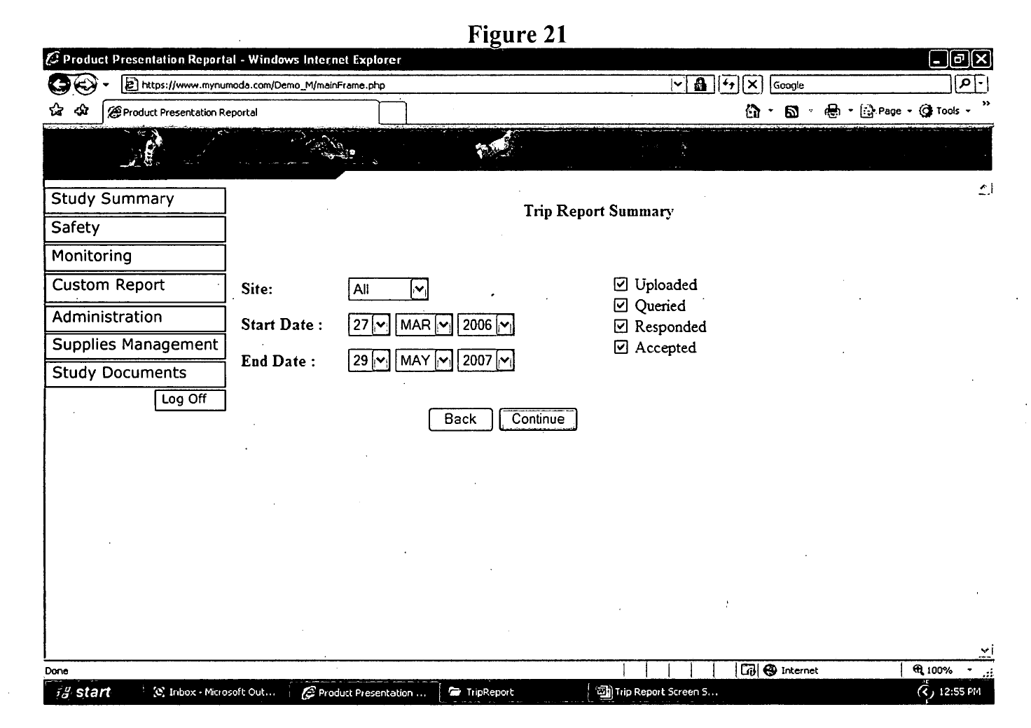

Once the trip report has been uploaded, a Sponsor or Project Manager can review the report. This is accomplished though the login screen (FIG. 15), selecting Monitoring from the main menu (FIG. 16) and selecting Trip Report Management from the monitoring menu (FIG. 17). The user then selects View Trip Report Summary from the Trip Report Management menu (FIG. 18), Region/Country screen is displayed (FIG. 20) and the user can select the region or country. The Trip Report Summary screen is displayed (FIG. 21) and the user can select the sites, date range and type of report based on status. Once selected, the report will be displayed (FIG. 22a) based on the criteria selected by the user.

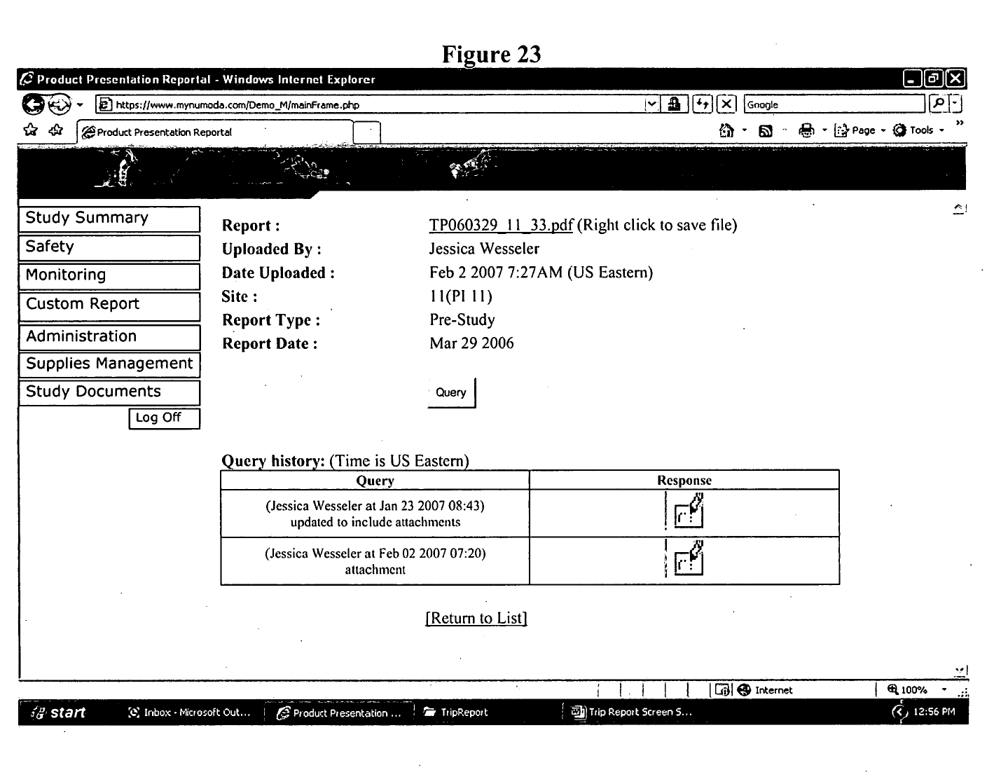

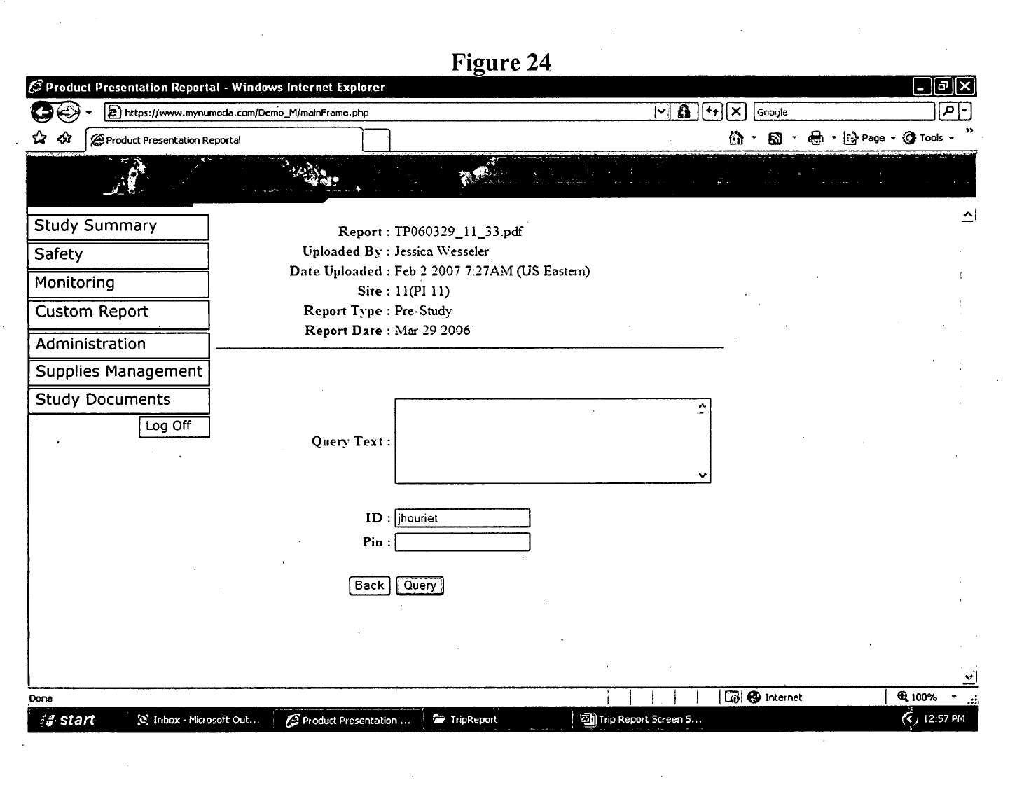

The Sponsor or Project Manager may now view the specific report by selecting the view button (FIG. 22a) to display the view screen (FIG. 23). The user may save a copy of the report on the local computer for viewing by right clicking on the file name. Also displayed are the details about the report itself. If the Sponsor or Project Manager find something questionable about the report, they may issue a query by selecting the query button (FIG. 23) to instantiate the query entry screen (FIG. 24). Text may be entered in the box stating the question to be made to the Monitor and saved in the database by entering the user ID and password of the person making the query.

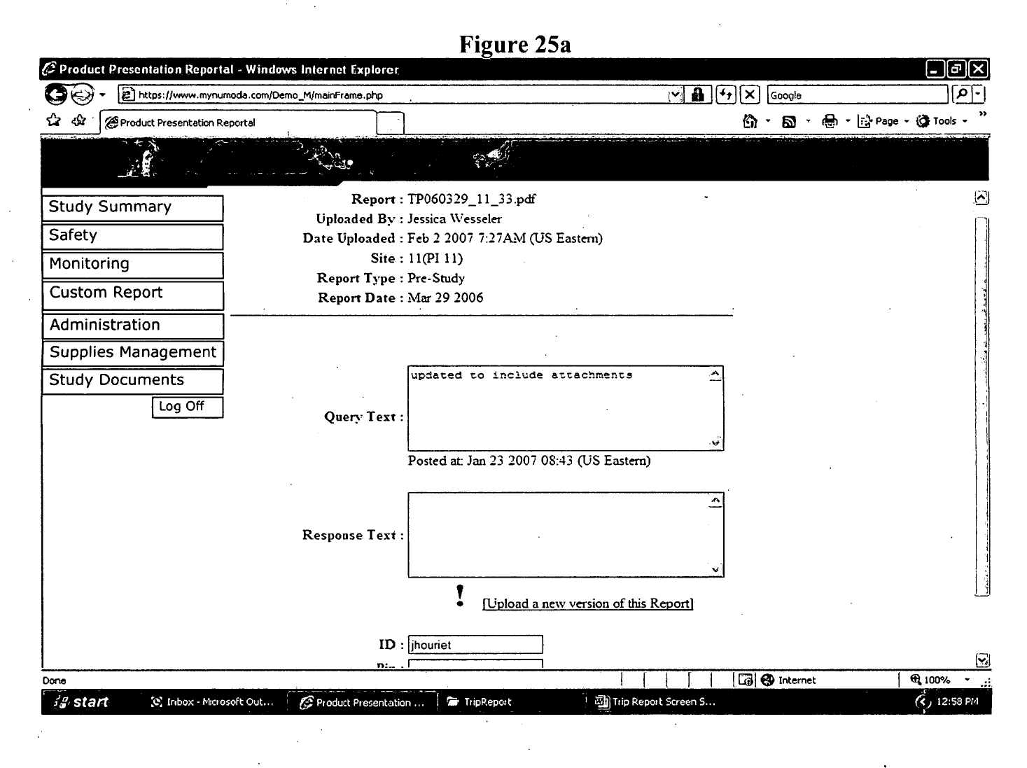

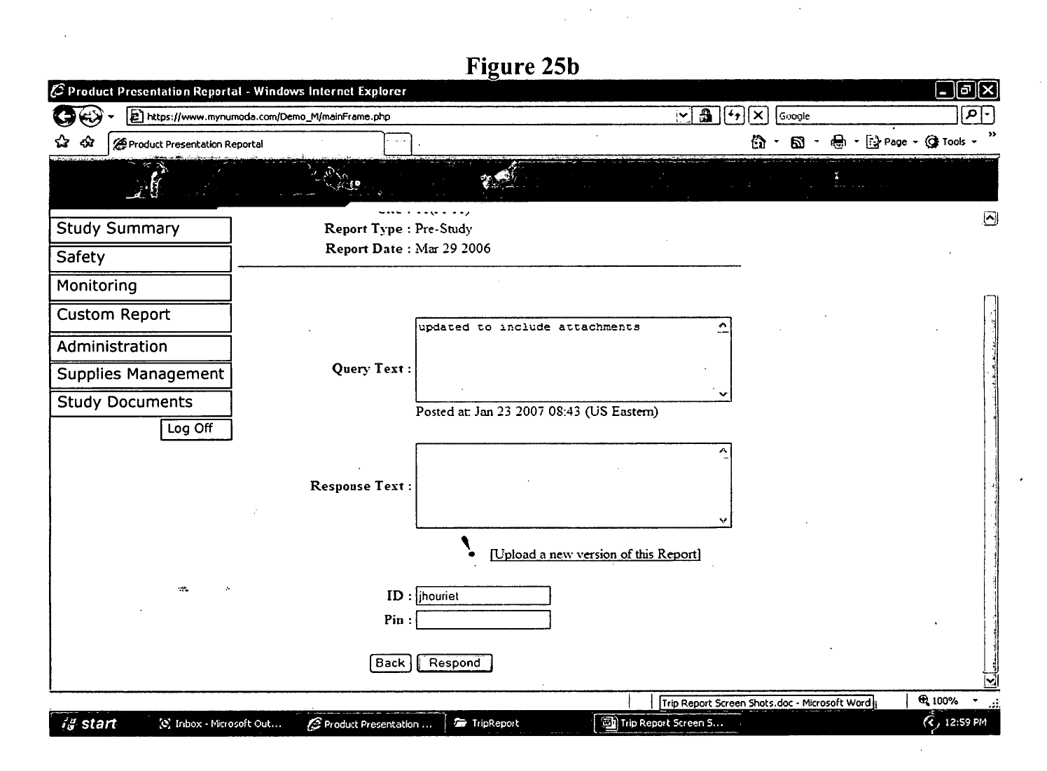

The Region Upload user may then respond to the query. They can access the queried reports in the same way described above to access the trip report list (FIG. 22a) and report details (FIG. 23) for reports marked with a status of Query. The user may then select the response button (FIG. 23) to display the response screen (FIGS. 25a and 25b). The user may then enter a response to the query, and may also upload a revised copy of the trip report itself.

Once a trip report is acceptable, either in its original form or an update version, the report can be marked as accepted by the Sponsor from the Report Details screen (FIG. 23). As more reports come into the system, the process can repeat with the goal of having the sponsor review and approve all of the trip reports put into the system.

At any time during the process, the Sponsor and the Project Manager can view a report that summarizes the visits made and days on site by month for accounting accrual and invoice reconciliation purposes. This report can be selected using the same process of accessing the Trip Report Summary screen as above to generate the Monthly Summary (FIG. 22b). The Monthly Summary may further include Trip Duration data for each of the corresponding different trip types, either in a separate part of the report as shown in FIG. 22b or in columns adjacent to each of the columns for the different trip report types.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media is encoded with, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A computer-implemented method of managing trip reports related to clinical monitoring, each trip report including a trip status, the method comprising:
(a) providing an administration computer that maintains a plurality of trip reports associated with a clinical study;
(b) entering trip reports into the administration computer;
(c) providing a user interface that allows authorized users to:
(i) view the trip reports, and
(ii) change the status of the trip reports in the administration computer; and
(d) the administration computer producing a summary report showing at least the status of selected trip reports.

2. The method of claim 1 wherein each trip report further includes a trip type and step (b) further comprises entering the trip type during the trip report entering, the summary report also showing the trip type.

3. The method of claim 2 wherein the trip type includes:
(i) a report made prior to or at the start of the study,
(ii) a report made during the course of the study, and
(iii) a report made at the end of the study.

4. The method of claim 1 wherein the status of the trip report includes at least two of the following:
(i) trip report has been uploaded,
(ii) inquiry has been made about selected content of the trip report,
(iii) response has been made to the inquiry, and
(iv) trip report has been accepted.

5. The method of claim 4 wherein at least one of the statuses is that a trip report has been uploaded, the method further comprising:
(e) automatically identifying the status of the trip report as being that the trip report is uploaded when a trip report is entered into the administration computer.

6. The method of claim 1 wherein step (b) is performed via the user interface.

7. The method of claim 1 wherein each trip report is associated with a clinical monitoring site.

8. The method of claim 1 wherein the status of the trip reports can only be changed while viewing the trip reports.

9. A computer-implemented method of managing trip reports related to clinical monitoring, each trip report including a trip date and trip duration, the method comprising:
(a) providing an administration computer that maintains a plurality of trip reports associated with a clinical study;
(b) entering trip reports and respective trip dates and trip durations into the administration computer; and
(c) the administration computer producing a summary report for a plurality of entered trip reports that shows for a plurality of successive time periods:
(i) the total number of entered trip reports, and
(ii) the trip duration spent to produce the entered trip reports.

10. The method of claim 9 wherein each trip report further includes a trip type, wherein there are a plurality of different trip types, the summary report showing the total number of entered trip reports and the trip durations for one or more of the different trip types.

11. The method of claim 10 wherein the trip type includes at least two of the following:
(i) a report made prior to or at the start of the study,
(ii) a report made during the course of the study, and
(iii) a report made at the end of the study.

12. The method of claim 9 wherein each trip report further includes a trip status, wherein there are plurality of different trip statuses, the summary report showing the total number of entered trip reports for one or more of the different trip statuses.

13. The method of claim 12 wherein one of the trip statuses is that a trip report has been accepted, and the summary report shows the total number of entered trip reports for at least the accepted trip reports.

14. The method of claim 9 wherein step (b) occurs via a user interface.

15. The method of claim 9 wherein each trip report further includes a trip status, wherein there are plurality of different trip statuses including a status of being accepted, and the summary report produced in step (c) is made only for the trip reports having an accepted status.
